(19) United States
(12) Patent Application Publication
(10) Pub. No.: US 2016/0125910 A1
(43) Pub. Date: May 5, 2016

(54) Networked Divided Electronic Video Messaging System and Method

(71) Applicant: Vaporstream, Inc., Chicago, IL (US)

(72) Inventors: Amit Jindas Shah, Chicago, IL (US); Aijaz Ansari, Glendale Heights, IL (US)

(73) Assignee: Vaporstream, Inc., Chicago, IL (US)

(21) Appl. No.: 14/532,381

(22) Filed: Nov. 4, 2014

(51) Int. Cl. G11B 20/00; G11B 27/031

(52) U.S. Cl. CPC G11B 20/00086; G11B 27/031

(57) ABSTRACT

A video received over a network is provided to a computing device with machine executable display instructions for allowing a display of each frame of a plurality of frames of a video in a separate successive screen display. The video may be divided at one or more computers prior to display. Each portion can be displayed in a subregion of a video display region corresponding to a subregion of the portion in the frame. One or more interfaces may also be provided to a user for dividing frames of a video, modifying an image parameter of one or more portions of one or more frames, designating a recipient for a transmitted video, providing additional visual information to a video, and/or for providing other functions. Systems, methods, and machine readable hardware storage media are provided for transmitting a video.

### RELATED APPLICATION DATA

This application is related to the following commonly-owned applications, each filed on the same day as the current application: U.S. patent application Ser. No. ______, titled “Electronic Image Separated Viewing and Screen Capture Prevention System and Method;” U.S. patent application Ser. No. ______, titled “Divided Electronic Image Transmission System and Method;” U.S. patent application Ser. No. ______, titled “Networked Divided Electronic Image Messaging System and Method;” U.S. patent application Ser. No. ______, titled “Separated Viewing and Screen Capture Prevention System and Method for Electronic Video;” and U.S. patent application Ser. No. ______, titled “Electronic Video Division and Transmission System and Method;” each of which is incorporated by reference herein in its entirety.

### FIELD OF INVENTION

The present invention generally relates to the field of electronic video messaging, modification, and display. In particular, the present invention is directed to a networked divided electronic video messaging system and method.

### BACKGROUND

As computing technologies and the Internet have grown, the ability to transfer larger amounts of data over a network has grown to be available to many people from a number of modes of communication. The myriad of applications, sometimes referred to simply as “apps,” available for mobile computing (e.g., smartphones, tablets, etc.) along with increasing bandwidth potential have created new avenues for creative electronic messaging, including messaging and network communication of images (e.g., an electronic photograph) and video in electronic form.

Sometimes a user would like to view, and/or send to someone else to view, an image or video. Several mechanisms exist for a user to transmit an image from one computing device to another computing device. Snapchat, Inc., for example, provides an app (SNAPCHAT) that allows a sending user to set a fixed amount of time that a recipient of an image or video has to view the image or video before the image or video is no longer viewable by the recipient. A recipient user can screen capture that image or video prior to the expiration of the time period for viewing. A screen capture creates a captured image of the display screen of the computing device and, thus, can preserve the received image or a still of the received video. ContentGuard, Inc. markets an app, YOVO, which allows display of an image with a filter over the image. The filter makes a screen captured image appear less desirable. The filter seems to move across the display of the image while the image is displayed such that any screen capture will also include the filter.

### SUMMARY OF THE DISCLOSURE

In one example implementation, a method of transmitting an electronic video is provided. The method includes receiving a video over a network from a first computing device, the video including a plurality of frames; and providing the video and machine executable display instructions to a second computing device, the machine executable display instructions allowing the second computing device to display a set of separate successive screen displays for each frame of at least a set of the plurality of frames in a video display region, the video display region having an area representative of a frame of the video, each frame of the at least a set of the plurality of frames being divided into a plurality of portions, the displaying a set of separate successive screen displays including displaying each portion of the plurality of portions for the frame in a separate successive screen display in a subregion of the area that corresponds to the location of the portion in the corresponding frame and displaying one or more substitute portions in any subregion not having the portion.

In another example implementation, a system for transmitting an electronic video is provided. The system includes a means for receiving a video over a network from a first computing device, the video including a plurality of frames; and a means for providing the video and machine executable display instructions to a second computing device, the machine executable display instructions allowing the second computing device to display a set of separate successive screen displays for each frame of at least a set of the plurality of frames in a video display region, the video display region having an area representative of a frame of the video, each frame of the at least a set of the plurality of frames being divided into a plurality of portions, the displaying a set of separate successive screen displays including displaying each portion of the plurality of portions for the frame in a separate successive screen display in a subregion of the area that corresponds to the location of the portion in the corresponding frame and displaying one or more substitute portions in any subregion not having the portion.

In yet another example implementation a machine-readable hardware storage medium containing machine executable instructions for transmitting an electronic video, is provided. The instructions include a set of instructions for receiving a video over a network from a first computing device, the video including a plurality of frames; and a set of instructions for providing the video and machine executable display instructions to a second computing device, the machine executable display instructions allowing the second computing device to display a set of separate successive screen displays for each frame of at least a set of the plurality of frames in a video display region, the video display region having an area representative of a frame of the video, each frame of the at least a set of the plurality of frames being divided into a plurality of portions, the displaying a set of separate successive screen displays including displaying each portion of the plurality of portions for the frame in a separate successive screen display in a subregion of the area that corresponds to the location of the portion in the corresponding frame and displaying one or more substitute portions in any subregion not having the portion.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A illustrates one exemplary implementation of a set of frames of a video;

FIG. 1B illustrates one exemplary implementation of a division of the set of frames of FIG. 1A into a plurality of portions;

FIG. 1C illustrates one exemplary implementation of a display of the plurality of portions of each of the frames of FIG. 1B;

FIG. 2A illustrates another exemplary implementation of a set of frames of a video;

FIG. 2B illustrates one exemplary implementation of a division of the set of frames of FIG. 2A into a plurality of portions;

FIG. 2C illustrates another exemplary implementation of a division of the set of frames of FIG. 2A into a plurality of portions;

FIG. 2D illustrates one exemplary implementation of a display of the plurality of portions of each of the frames of FIG. 2C;

FIG. 3A illustrates one exemplary implementation of a normalized coordinate scale for an example frame;

FIG. 3B illustrates one set of exemplary coordinates of example portions of a frame via the exemplary coordinate scale of FIG. 3A;

FIG. 4 illustrates one exemplary implementation of one embodiment of a method of displaying a plurality of portions for each of a plurality of frames from a video;

FIG. 5 illustrates one example of a portable handheld computing device;

FIG. 6 illustrates another example of a portable handheld computing device;

FIG. 7 illustrates one example diagrammatic representation of one implementation of a computing device;

FIG. 8A illustrates one exemplary implementation of a display of a first example portion of a first frame of a set of frames from a video in an exemplary separate successive display of a plurality of portions;

FIG. 8B illustrates one exemplary implementation of a display of a second example portion of a first frame of a set of frames from a video in an exemplary separate successive display of a plurality of portions;

FIG. 8C illustrates one exemplary implementation of a display of a first example portion of a second frame of a set of frames from a video in an exemplary separate successive display of a plurality of portions;

FIG. 8D illustrates one exemplary implementation of a display of a second example portion of a second frame of a set of frames from a video in an exemplary separate successive display of a plurality of portions;

FIG. 8E illustrates one exemplary implementation of a display of a first example portion of a third frame of a set of frames from a video in an exemplary separate successive display of a plurality of portions;

FIG. 8F illustrates one exemplary implementation of a display of a second example portion of a third frame of a set of frames from a video in an exemplary separate successive display of a plurality of portions;

FIG. 9A illustrates one example of a substitute portion used in an exemplary separated display of portions of a frame of a video;

FIG. 9B illustrates another example of a substitute portion used in an exemplary separated display of portions of a frame of a video;

FIG. 10A illustrates yet another example of a substitute portion used in an exemplary separated display of portions of a frame of a video;

FIG. 10B illustrates still another example of a substitute portion used in an exemplary separated display of portions of a frame of a video;

FIG. 11 illustrates one exemplary implementation of method of dividing a video into a plurality of portions;

FIG. 12 illustrates another exemplary implementation of method of dividing a video into a plurality of portions;

FIG. 13 illustrates yet another exemplary implementation of method of dividing a video into a plurality of portions;

FIG. 14A illustrates one exemplary implementation of an interface for dividing a video;

FIG. 14B illustrates the exemplary interface for dividing a video of FIG. 14A with an example of a line positioned to divide one exemplary representation of one or more frames of a video;

FIG. 14C illustrates the exemplary interface for dividing a video of FIG. 14A with another example of a line positioned to divide one exemplary representation of one or more frames of a video;

FIG. 15 illustrates one example of a networking environment;

FIG. 16 illustrates another example of a networking environment;

FIG. 17 illustrates one exemplary implementation of a method of transmitting a video;

FIG. 18 illustrates one exemplary implementation of a method of displaying a divided video;

FIG. 19 illustrates another exemplary implementation of a method of displaying a divided video;

FIG. 20 illustrates yet another exemplary implementation of a method of displaying a divided video;

FIG. 21 illustrates one exemplary implementation of an interface for designating one or more recipients for a video;

FIG. 22 illustrates another exemplary implementation of an interface for dividing a video;

FIG. 23A illustrates one exemplary implementation of an example representation of one or more frames of a video;

FIG. 23B illustrates one exemplary implementation of an automatic division of the representation of FIG. 23A into a plurality of portions using facial recognition; and

FIG. 23C illustrates one exemplary implementation of a display of separated portions of FIG. 23B.

### DETAILED DESCRIPTION

A digital video (also referred to herein as “video”) may be any recording of a set of images (frames) arranged in an order for playback. Many formats of video files are known and may be developed in the future, any of which may be utilized in one or more of the implementations and embodiments disclosed herein. In addition to video data, a video file may also include audio data, synchronization information, subtitles, metadata (e.g., title, date, time, etc.), and/or other information data. A video may also include data representing a desired frame rate. A frame rate indicates the number of frames of a video to be displayed in a set amount of time (e.g., frames per second). Example video formats include, but are not limited to, Windows Media Video (WMV) format, a Flash Video (FLV) format, a QuickTime File Format (MOV), a WebM format, a Moving Pictures Experts Group (MPEG) format (e.g., MPEG-1, MPEG-2, MPEG-4), an M4V format, a RealMedia (RM) format, a RealMedia Variable Bitrate (RMVB) format, an AVI format, a Matroska Multimedia (MKV) format, a Video Object (VOB) format, and any combinations thereof. A video may be in the form of one or more streams of video.

A video includes a plurality of frames. In one exemplary aspect, a frame is a display of a visual image and a video typically includes a plurality of frames displayed in succession. Different video formats may approach the storage of data representing a frame in different ways. For example, data representing a frame may be stored in a compressed format. In one example, compression may store less than all of the data for every frame (e.g., where one or more pixels of multiple frames in the video are the same). Examples of a compression format include, but are not limited to, H.120, H.261, H.262, H.263, H.264, H.265, VC-2, MPEG-2, MPEG-4, and any combinations thereof.

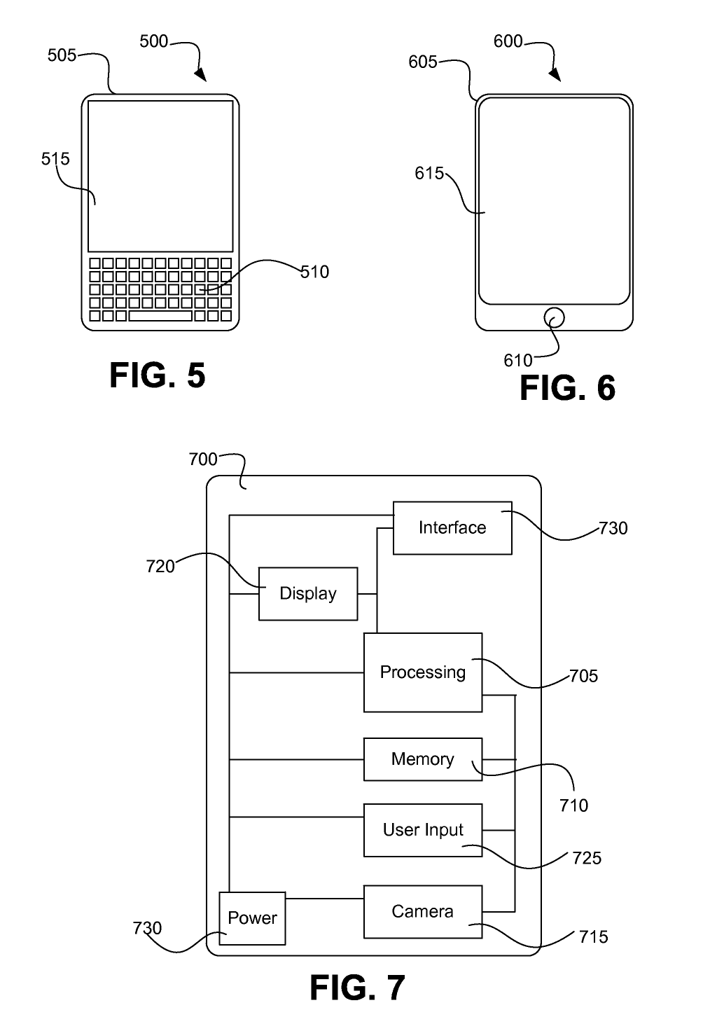

A video may be utilized using one or more computing devices. For example, a video can be acquired by, modified with, divided by, displayed by, transmitted from, and/or received by one or more computing devices. A computing device is any machine that is capable of executing one or more machine-executable instructions to perform one or more tasks. Examples of a computing device include, but are not limited to, a smartphone, a tablet, an electronic book reading device, a workstation computer, a terminal computer, a server computer, a personal digital assistant (PDA), a mobile telephone, a portable and/or handheld computing device, a wearable computing device (e.g., a watch), a web appliance, a network router, a network switch, a network bridge, one or more application specific integrated circuits, an application specific programmable logic device, an application specific field programmable gate array, any machine capable of executing a sequence of instructions that specify an action to be taken by that machine (e.g., an optical, chemical, biological, quantum and/or nanoengineered system and/or mechanism), and any combinations thereof. In one example, a computing device is a smartphone. A computing device may utilize any of a variety of known or yet to be developed operating systems. Examples of an operating system include, but are not limited to, Apple's iOS, Blackberry operating system, Amazon's Fire OS, Google's Android operating system, Microsoft's Windows Phone operating system, Samsung's Bada operating system, Microsoft's Windows operating system, Apple's Operating System X, a Linux-kernel based operating system, and any combinations thereof. Example implementations of a smartphone are discussed further below with respect to FIGS. 5 and 6. An additional example of a computing device and computing environment are discussed further below with respect to FIG. 7. A computing device may include and/or be programed with specific machine-executable instructions and include required circuitry and components such that the combination of the circuitry/components and the instructions allow it to perform as a specialized machine in one or more of the implementations disclosed in the current disclosure.

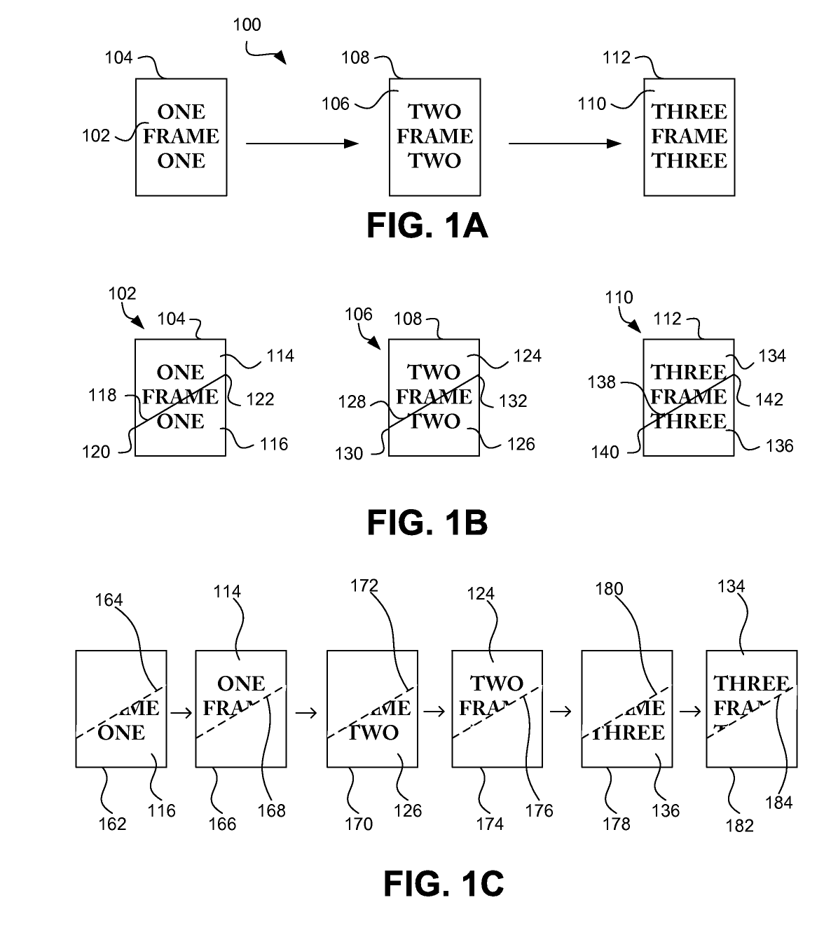

FIGS. 1A to 1C illustrate one exemplary implementation of a video 100 with a plurality of frames each divided into a plurality of portions. For discussion purposes, FIGS. 1A to 1C show three frames of the plurality of frames, each divided into two portions. It should be noted that where a set number of frames and/or portions are used in one or more examples and/or implementations, any other number of frames and/or portions may be utilized.

FIG. 1A illustrates an exemplary depiction of a frame 102 having a perimeter 104. Frame 102 is shown in succession with frame 106 having a perimeter 108 and frame 110 having a perimeter 112. Video 100 may include additional frames before frame 102 and/or after frame 110. A perimeter of a frame (e.g., perimeters 104, 108, 112) is the edge of the visual image depicted in the frame. Perimeters 104, 108, 112 are shown in FIGS. 1A to 1C as a visible outline demarcation for the purposes of assisting the visualization of the edges of frames 102, 106, 110, respectively. A perimeter of a frame and/or video displayed via a computing device may or may not have such a visible outline when displayed. For example, a display of a frame of a video on a display element of a computing device may include the emission of light from the display element based on the data representing the frame in such a way that the emission of light representing the frame terminates at the edges of the frame on the display element (e.g., pixels adjacent to the pixels of the edges of the frame may be non-active regions of the display element and/or other active regions of the display element representing the display of items other than the frame without a visible demarcation, such as the lined perimeter shown in the figures of the current disclosure for visualization purposes). Example display elements are discussed further below. Frames depicted in the figures of this disclosure with a border demarcation also exemplify a frame display without such a border demarcation. It is also noted that frames shown in figures of this disclosure (e.g., frames 102, 106, 110) may include text depictions (“FRAME ONE,” “FRAME TWO,” “FRAME THREE,” etc.) for assisting with understanding of the figures. A frame may depict any subject matter that is capable of being recorded in a video. Additionally, a displayed frame may only display a part of the original frame due to down-sampling, cropping, and/or stretching.

Frames 102, 106, 110 each have an area of the displayable frame within perimeters 104, 108, 112, respectively. Frames 102, 106, 110 are shown as having a rectangular shape oriented in a portrait orientation (i.e., with a height greater than a width). Frames of a video may have any of a variety of shapes and configurations (orientation, aspect ratio, resolution, etc.). For example, a rectangular frame in one or more other examples may have a landscape orientation (i.e., with a width greater than a height). Example shapes for a frame of a video include, but are not limited to, a square, a rectangle, a circle, a polygon, an ellipse, a triangle, a diamond, a shape with no corners, a shape with no edges, a shape with no vertices, and any combinations thereof.

FIG. 1B illustrates an exemplary division of frames 102, 106, 110. Frame 102 is shown divided into two portions (a portion 114 and a portion 116) at a line 118. Similar to the depictions of a border outline, a line shown in the figures of this disclosure between portions of a frame may or may not be visible in a display of one or more of the portions of a frame. Line 118 connects edges of the frame at perimeter 104 at location 120 and location 122. A line dividing a frame may be any type of line. Examples of a line include, but are not limited to, a straight line, a curved line, a wave-shaped line, a jagged line, and any combinations thereof. Line 118 stops at the edges of the frame. A line at a division of portions of a frame may extend beyond the edges of the frame (e.g., even though the parts of the line extending beyond the edges may not be necessary to define the separation of portions). A line dividing a frame may have an appearance with a visible line width when the line is displayed, such as when displayed as part of an interface for dividing one or more frames of a video or a display screen for displaying one or more portions separately (examples of which are discussed in more detail below). Segments of the frame that share the same area as the line (e.g., displayed pixels of the frame that are covered by the display of the line) may be handled in a variety of ways with respect to which portion to assign the segments. Examples of ways to handle the assignment of segments of a frame occupying the same area as a line include, but are not limited to, assigning some of the shared segment of a frame to one portion and some of the shared segment of the frame to the another portion, treating the line as having no width (e.g., by defining each portion based on points of intersection of the line with a perimeter of the frame and/or with another line), assigning all of the shared segment of a frame to one portion, and any combinations thereof.

Portion 114 occupies a first subregion of the area of frame 102 and portion 116 occupies a second subregion of the area of frame 102. Frame 106 is shown divided into a portion 124 and a portion 126 at line 128 that connects edges of perimeter 108 at location 130 and location 132. Portion 124 occupies a first subregion of the area of frame 106 and portion 126 occupies a second subregion of the area of frame 106. Frame 108 is shown divided into a portion 134 and a portion 136 at line 138 that connects edges of perimeter 112 at location 140 and location 142. Portion 134 occupies a first subregion of the area of frame 110 and portion 136 occupies a second subregion of the area of frame 110. Frames 102, 106, 110 are each shown divided into two portions. A frame of a video can be divided into any number of two or more portions (e.g., via any number of lines and/or other techniques for dividing an image). Portions 114, 116, 124, 126, 134, 136 are each shaped as a polygon with four sides each and vertices at each corner.

In one exemplary aspect, a video may be divided by dividing each frame of one or more sets of frames into a plurality of portions. A frame of a video can be divided in a variety of ways. Example ways of dividing a frame of a video include, but are not limited to, using a user interface via a computing device, positioning a line at a location of a frame, dividing a frame into a plurality of polygons, automatically defining two or more portions of a frame, and any combinations thereof. In one example, a user interface is provided to a user of a computing device, the interface being configured to allow the user to input instructions for dividing one or more frames of a video into a plurality of portions. In another example, a user interface is provided to a user of a computing device, the interface being configured to allow the user to position one or more lines to divide each of one or more frames into a plurality of portions. In yet another example, a user interface is provided to a user of a computing device, the interface being configured to allow the user to define a plurality of polygons dividing one or more frames into a plurality of portions. In still another example, a computing device automatically divides one or more frames into a plurality of portions. Automatic division of one or more frames may be performed by a computing device specially programmed for the dividing by any of a variety of ways consistent with the current disclosure. Examples of ways to automatically divide one or more frames include, but are not limited to, using facial recognition to identify a region of a frame containing at least part of a face of a subject in the image and dividing the frame to place the at least part of a face in a first portion, randomly dividing a frame into two or more portions, using a predefined location for dividing a frame into two or more portions, using predefined information to divide a frame into two or more portions, and any combinations thereof.

Any number of frames of a video can be divided into a plurality of portions. In one example, all of the frames of a video are divided into a plurality of portions. In another example, a set of less than all of the frames of a video are divided into a plurality of portions. Dividing more than one frame of a video can be achieved in a variety of ways. For example, a user interface may provide one frame to user at a time to allow the user to divide each frame separately. In another example, a user interface may provide a user with an ability to input instructions for dividing one or more sets of more than one frame into a plurality of portions at the same time. In one such example, an interface may present a user with a representation of a plurality of frames to allow the user to divide the frames into two or more portions. Examples of a representation of a plurality of frames include, but are not limited to, a still frame of a selected one of the plurality of frames, a graphic having about the same shape as the plurality of frames, a graphic having a different shape as the plurality of frames, a graphic having a different size as the plurality of frames, a graphic having the same size as the plurality of frames, a video representation having moving video of a selection of the plurality of frames, and any combinations thereof.

Each divided frame of a video may be divided in the same fashion, such that the portions of one frame have the same shape and size of corresponding portions of the other frames in the video. Alternatively, one or more frames of a video may be divided differently. For example, one set of frames may be divided in a first fashion and another set of frames may be divided in a second fashion. In another example, every frame in a video is divided differently.

A divided video may be in a variety of forms that allow the display of the portions of each frame to be displayed separately. Example forms of a divided video include, but are not limited to, separate video files for each set of corresponding portions of a plurality of frames (i.e., a first set of corresponding portions from all frames in one video file, a second set of corresponding portions from all frames in another video file, etc.), a video file associated with segment information defining the division of frames, and any combinations thereof. Segment information can be used to display a divided video via a computing device with each portion of each divided frame of a video being displayed separately in a successive display screen. Examples of segment information include, but are not limited to, user defined information, one or more coordinates defining a location and/or shape of a portion in a frame, information regarding a shape of a portion within a frame, information regarding a location of a portion within a frame, information identifying vertices of a polygon-shaped portion, file correlation information for combining separate image files, and any combinations thereof. Examples of coordinate information includes, but is not limited to, coordinate information based on a normalized coordinate system of a frame, coordinate information based on an absolute measurement of dimensions of a frame, one or more coordinates of one or more lines, one or more coordinates of a set of vertices for a polygon shaped portion, one or more coordinates expressed in points, one or more coordinates expressed in percentages, one or more coordinates expressed in pixels, one or more coordinates expressed in another unit (e.g., inches, centimeters, millimeters, pica, etc.), another coordinate system, and any combinations thereof. Segment information may be associated with a video file in a variety of ways including, but not limited to, as a separate file from a video file, as file metadata, and/or as data embedded in a video file.

A divided video may provide one or more benefits in displaying the divided video with portions of frames displayed in separate screen displays. Examples of a benefit include, but are not limited to, prevention of screen capture of an entire frame of a video, protection of identity of a subject within a video, an entertainment benefit, prevention of recording of a video with another video and/or still image capture device, and any combinations thereof.

Each of the plurality of portions of a plurality of the frames of a divided video can be displayed via a computing device. In one example, a divided video is displayed at a computing device used to divide the video. In another example, a divided video is displayed at a different computing device from the computing device used to divide the video. A video, a divided video, and/or one or more portions of a video (along with other information) may be transmitted from one computing device (e.g., a “sending computing device”) to another computing device (e.g., a “recipient computing device”). An intermediate computing device (e.g., a server computing device) may also be employed in a transmission.

FIG. 1C illustrates an exemplary display of the portions of frames 102, 106, 110. FIG. 1C shows screen displays 162, 166, 170, 174, 178, and 182 displayed in succession. Screen displays 162, 166, 170, 174, 178, and 182 each includes a separate display of portion 116, 114, 126, 124, 136, 134, respectively. Screen displays 162, 166, 170, 174, 178, and 182 have an area that is similar in shape and proportional in size to the corresponding frame from which the displayed portion was divided. Other configurations for an area of a screen display may also be representative of an area of a frame. For example, a screen display may have a different shape and or size configuration than that of the original frame. Screen displays are shown in the figures with a visible rectangular border demarcation for assistance in visualizing the screen display area. A dashed line 164, 168, 172, 176, 180, 184 is utilized in the depiction to assist with visualizing the boundary of portion 116, 114, 126, 124, 136, 134, respectively. A border demarcation and/or a dashed line may or may not be visible in a display of a portion of a frame of a video. In one such example, a portion of a frame may be displayed without a border demarcation as to the edge of the frame or portion of frame (e.g., other than the edges of the portion itself, the display of a computing device, and/or the display region of a display element of a computing device).

Each portion of frame 102 is displayed separately. Portion 116 occupies a first subregion of screen display 162. Other subregions of screen display 162 do not include display of other portions of frame 102. Portion 114 occupies a first subregion of screen display 166. Other subregions of screen display 166 do not include display of other portions of frame 102.

Each portion of frame 106 is displayed separately. Portion 126 occupies a first subregion of screen display 170. Other subregions of screen display 170 do not include display of other portions of frame 106. Portion 124 occupies a first subregion of screen display 174. Other subregions of screen display 174 do not include display of other portions of frame 106.

Each portion of frame 110 is displayed separately. Portion 136 occupies a first subregion of screen display 178. Other subregions of screen display 178 do not include display of other portions of frame 110. Portion 134 occupies a first subregion of screen display 182. Other subregions of screen display 182 do not include display of other portions of frame 110. Portions 116, 114, 126, 124, 136, 134 can each be displayed separately in successive screen displays (e.g., as shown by the arrows in the figures).

A screen display (such as screen displays 162, 166, 170, 174, 178, 182) may be displayed via a video display region of a display element. A video display region may have an area that corresponds to an area of a frame for which a portion is to be displayed. A video display region is a region of a display element associated with a computing device configured for the display of one or more portions of frames of a video. Examples of a display element include, but are not limited to, a computer monitor, a liquid crystal display (LCD) display screen, a light emitting diode (LED) display screen, a touch display, a cathode ray tube (CRT), a plasma display, and any combinations thereof. A display element may include, be connected with, and/or associated with adjunct elements to assist with the display of still and/or moving images. Examples of an adjunct display element include, but are not limited to, a display generator (e.g., video/image display circuitry), a display adapter, a display driver, machine-executable instructions stored in a memory for execution by a processing element for displaying still and/or moving images on a screen, and any combinations thereof.

Two devices, components, elements, and or other items may be associated with each other in a variety of ways. Example ways to associate two items include, but are not limited to, one item being an internal component to another item, one item being an external portion to another item (e.g., an external LED touch screen of a smartphone computing device), one item being connected externally to another item via a wired connection (e.g., a separate LED display device connected via a wire to a computing device, an external memory device connected via a Universal Serial Bus (USB) connection to a computing device, two items connected via Ethernet), one item being connected externally to another item via a wireless connection (e.g., two devices connected via a Bluetooth wireless, cellular, WiFi connection and/or other wireless connection), one item connected to another item via an external port or other connector of the other item (e.g., a USB flash drive, such as a “thumb drive” plugged into an external USB port of a computing device), one item removeably connected to another item, and any combinations thereof.

A video display region may occupy any amount of the displayable portion of a display element. A displayable portion of a display element is the portion of the display element capable of producing a visible display to a user. In one example, a video display region occupies substantially the entire displayable portion of a display element. In another example, a video display region occupies part of the displayable portion of a display element.

A video display region can have a variety of shapes and configurations. Examples of a shape for a video display region include, but are not limited to, a square, a rectangle, a circle, a polygon, an ellipse, a triangle, a diamond, and any combinations thereof. In one example, a video display region has the shape of a frame for which the video display region is configured to display. In another example, a video display region has a shape different from a frame for which the video display region is configured to display.

A video in an undivided state may be displayed at a particular frame rate. A frame rate for a display of a video is the frequency at which consecutive images of a video (e.g., frames) are displayed. As discussed above, information related to a desired frame rate for a video may be included with and/or associated with a video file. In one example, a video may be captured by a camera at a captured frame rate. A display element may have one or more settings for a frame rate capability of the display element at which the display element can produce consecutive display of unique images. Examples of a frame rate of a display element include, but are not limited to, 24 frames per second, 23.976 frames per second (e.g., an NTSC standard frame rate), 25 frames per second (e.g., a PAL standard frame rate), 30 frames per second, 48 frames per second, 50 frames per second, 60 frames per second, 72 frames per second, 90 frames per second, 100 frames per second, 120 frames per second, and 300 frames per second. In one example, the consecutive images of a video displayed by a display element are unique images from one to the next. In another example, at least some of the consecutive images of a video displayed by a display element are not unique from one to the next. In one such example, the captured frame rate for the video is different from a frame rate capability of the display element (e.g., where the video is captured at a frame rate that is slower than that of the frame rate of the display element). One way to handle a situation where a capture frame rate is slower than a display element display rate is to display the same frame multiple times (e.g., with a capture frame rate of 30 frames per second and a display element display rate of 60 frames per second, each unique frame can be displayed twice or left displayed for a duration of two cycles).

For a display of each of a plurality of portions of frames in separate successive screen displays (e.g., that shown in FIG. 1C) the images displayed consecutively by a display element can be the screen displays (e.g., screen displays 162, 166, 170, 174, 178, 182). A display screen rate is the frequency of displaying a series of display screens of a process of displaying each of a plurality of portions of frames of a video in separate successive screen displays. An effective frame display rate is the frequency of display of sets of all the portion screen displays for a given frame. An effective frame display rate is the display screen rate divided by the number of screen displays corresponding to each frame. For example, in FIG. 1C each frame has two corresponding screen displays (each displaying one of two portions of the frame). In this example, if the display screen rate was 60 images per second (e.g., matching one of the capabilities of the display element display rate) the effective frame display rate is 30 frames per second (60 frames per second/2).

A display screen rate for a divided video may be the same as any of the frame rates supported by a display element. In one example, video captured at a frame rate of 60 frames per second with each frame divided into three portions can be displayed using a display screen rate of 60 images per second via a display element having a display frame rate capability of 60 frames per second such that the effective frame display rate is 20 frames per second (60 frames per second/3). In another example, video captured at a frame rate of 30 frames per second with each frame divided into two portions can be displayed using a display screen rate of 60 images per second via a display element having a display frame rate capability of 60 frames per second such that the effective frame display rate is 30 frames per second (60 frames per second/2).

A display element display rate and/or a display screen rate may vary during the display of a divided video. In one example, a divided video includes one or more undivided frames and/or sets of frames each divided into a different number of portions that require a change in the display screen rate to provide the same effective frame rate. In one such example, a video includes some frames divided into two portions and other frames undivided such that the sets of frames would have effective frame rates of (display screen rate/2) and (display screen rate/1). To maintain the same effective frame rate for both sets of frames in this example, the display screen rate for the set of undivided frames would be half the rate of the display screen rate for the set of frames divided into two portions. In another such example, a video includes a set of frames divided into two portions and a set of frames divided into four portions. To maintain the same effective frame rate for both sets of frames in this example, the display screen rate for the set of frames divided in four portions would be twice the frame rate of the set of frames divided into two portions. In one exemplary aspect, a similar effective frame rate may provide an impression to a viewer of a displayed divided video of a consistent video image (e.g., without flicker or other aberration of the different effective frame rates). An alternative way to provide a similar benefit would be to repeat successive display of an undivided frame one or more times to match the number of displayed portions of a divided frame and/or repeat the successive display of one or more portions of a frame divided into a lesser number of portions than another frame to match the number of screen displays corresponding to frames.

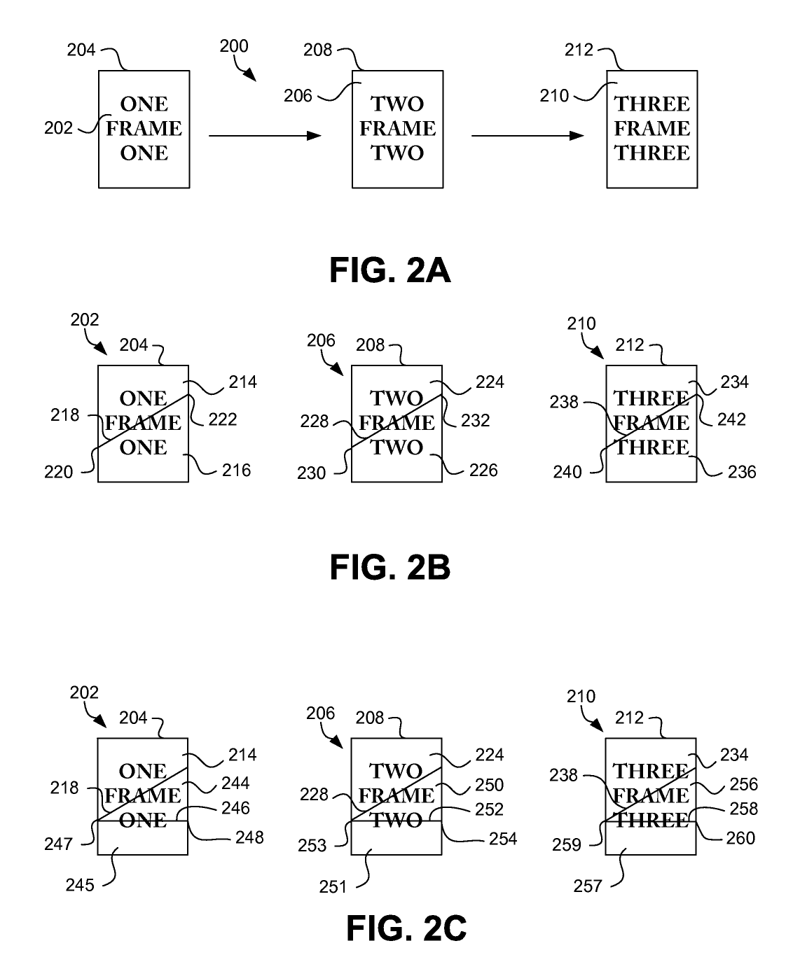

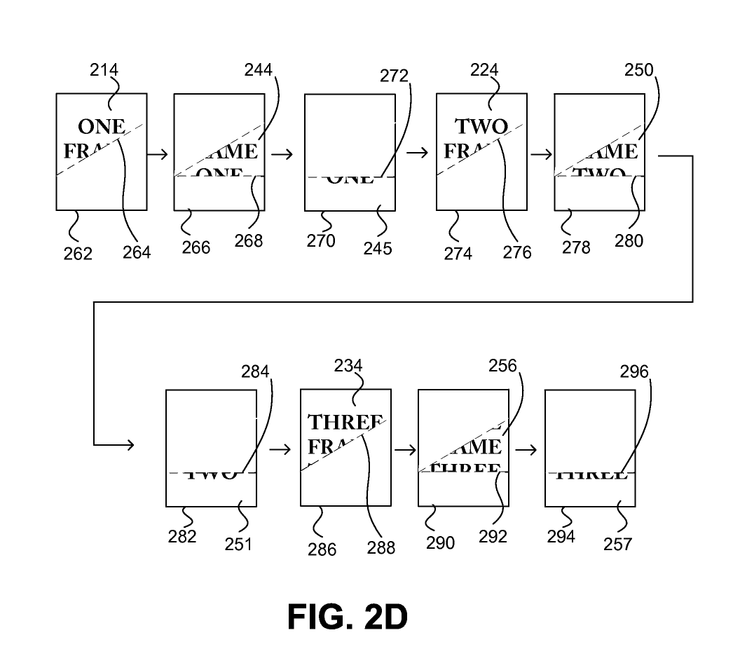

Additional implementations of display of a plurality of portions of frames of a video are discussed further below (e.g., with respect to FIGS. 2A to 2D, 4, 8A to 8F, 9A, 9B, 10A, 10B).

FIGS. 2A to 2D illustrate another exemplary implementation of a video 200 with a plurality of frames each divided into a plurality of portions. For discussion purposes, FIGS. 2A to 2D show three frames of the plurality of frames and division of each frame into three portions. It should be understood that video 200 may include additional frames and that one or more of the frames could be divided into any number of portions. For the sake of brevity, some of the details, concepts, aspects, features, characteristics, examples, and/or alternatives discussed above with respect to FIGS. 1A to 1C (and in other locations in this disclosure) are not repeated in the discussion of video 200 and FIGS. 2A to 2D. Any one or more of the details, concepts, aspects, features, characteristics, examples, and alternatives may be included to the implementation described in FIGS. 2A to 2D as applicable, except where noted.

FIG. 2A illustrates an exemplary depiction of a frame 202 having a perimeter 204. Frame 202 is shown in series with frame 206 having a perimeter 208 and frame 210 having a perimeter 212. Video 200 may include additional frames before frame 202 and/or after frame 210. Perimeters 204, 208, 212 are shown in FIGS. 2A to 2D as a visible outline border demarcation for the purposes of assisting the visualization of the edges of frames 202, 206, 210, respectively.

FIG. 2B illustrates an exemplary division of frames 202, 206, 210. Frame 202 is shown divided into two portions (a portion 214 and a portion 216) at a line 218. Line 218 connects edges of the frame at perimeter 204 at location 220 and location 222. Portion 214 occupies a first subregion of the area of frame 202 and portion 216 occupies a second subregion of the area of frame 202. Frame 206 is shown divided into a portion 224 and a portion 226 at line 228 that connects edges of perimeter 208 at location 230 and location 232. Portion 224 occupies a first subregion of the area of frame 206 and portion 226 occupies a second subregion of the area of frame 206. Frame 208 is shown divided into a portion 234 and a portion 236 at line 238 that connects edges of perimeter 212 at location 240 and location 242. Portion 234 occupies a first subregion of the area of frame 210 and portion 236 occupies a second subregion of the area of frame 210.

FIG. 2C illustrates a further exemplary division of frames 202, 206, 210. Portion 216 of frame 202 is further divided into a portion 244 and a portion 245 at a line 246 that connects edges of perimeter 204 at a location 247 and a location 248. Portion 214 occupies a first subregion of frame 202, portion 244 occupies a second subregion of frame 202, and portion 245 occupies a third subregion of frame 202. Portion 226 of frame 206 is further divided into a portion 250 and a portion 251 at a line 252 that connects edges of perimeter 208 at a location 253 and a location 254. Portion 224 occupies a first subregion of frame 206, portion 250 occupies a second subregion of frame 206, and portion 251 occupies a third subregion of frame 206. Portion 236 of frame 210 is further divided into a portion 256 and a portion 257 at a line 258 that connects edges of perimeter 212 at a location 259 and a location 260. Portion 234 occupies a first subregion of frame 210, portion 256 occupies a second subregion of frame 210, and portion 257 occupies a third subregion of frame 210.

It is noted that in this example, location 220 is the same as location 247, location 230 is the same as location 253, and location 240 is the same as location 259. In other examples, such correlation of overlap at the location of division may not occur. The lines at the divisions of the frames in the examples shown in FIG. 2C are each shown connecting edges of the frame without crossing the other line. In another example, a first line divides a frame by connecting two edges of the frame (i.e., at the perimeter) and a second line further divides the frame by connecting an edge of the frame and the first line. In one such example, one or more additional lines may also further divide the frame (e.g., by connecting edges of the frame, by connecting an edge of the frame to the first line, by connecting an edge of the frame to the second line, by connecting the first line to the second line, etc.). In yet another example, a first line divides a frame by connecting two edges of the frame and a second line further divides the frame by connecting an edge of the frame and the first line. In such an example, one or more additional lines may also further divide the frame (e.g., by connecting edges of the frame, by connecting an edge of the frame to the first line, by connecting an edge of the frame to the second line, by connecting the first line to the second line, etc.). In still another example, a first line divides a frame by connecting two edges of the frame and a second line further divides the frame by connecting edges of the frame and crossing the first line. In such an example, one or more additional lines may also further divide the frame (e.g., by connecting edges of the frame, by connecting an edge of the frame to the first line, by connecting an edge of the frame to the second line, by connecting the first line to the second line, etc.). Portions 214, 224, 234, 245, 251, and 257 are each shaped as polygons with four sides and vertices at each corner. Portions 244, 250, and 256 are each shaped as polygons with three sides and vertices at each corner. As discussed above, portions of a frame may be defined by their polygon shape and the location of the polygon shape.

FIG. 2D illustrates an exemplary display of the portions of frames 202, 206, 210. FIG. 2D shows screen displays 262, 266, 270, 274, 278, 282, 286, 290, 294 displayed in succession. Screen displays 262, 266, 270, 274, 278, 282, 286, 290, 294 each includes a separate display of portion 214, 244, 245, 224, 250, 251, 234, 256, and 257, respectively. Screen displays 262, 266, 270, 274, 278, 282, 286, 290, 294 have an area that is similar in shape and proportional in size to the corresponding frame from which the displayed portion was divided. A dashed line 264, 268, 272, 276, 280, 284, 288, 292, 296 is utilized in the depiction to assist with visualizing the boundary of portion 214, 244, 245, 224, 250, 251, 234, 256, and 257, respectively.

Each of the portions of frame 202 is displayed separately. Portion 214 occupies a first subregion of screen display 262. Other subregions of screen display 262 do not include display of other portions of frame 202. Portion 244 occupies a first subregion of screen display 266. Other subregions of screen display 266 do not include display of other portions of frame 202. Portion 245 occupies a first subregion of screen display 270. Other subregions of screen display 270 do not include display of other portions of frame 202.

Each of the portions of frame 206 is displayed separately. Portion 224 occupies a first subregion of screen display 274. Other subregions of screen display 274 do not include display of other portions of frame 206. Portion 250 occupies a first subregion of screen display 278. Other subregions of screen display 278 do not include display of other portions of frame 206. Portion 251 occupies a first subregion of screen display 282. Other subregions of screen display 282 do not include display of other portions of frame 206.

Each of the portions of frame 210 is displayed separately. Portion 234 occupies a first subregion of screen display 286. Other subregions of screen display 286 do not include display of other portions of frame 210. Portion 256 occupies a first subregion of screen display 290. Other subregions of screen display 290 do not include display of other portions of frame 210. Portion 257 occupies a first subregion of screen display 294. Other subregions of screen display 294 do not include display of other portions of frame 210. Portions 214, 244, 245, 224, 250, 251, 234, 256, and 257 can each be displayed separately in successive screen displays (e.g., as shown by arrows in the figures).

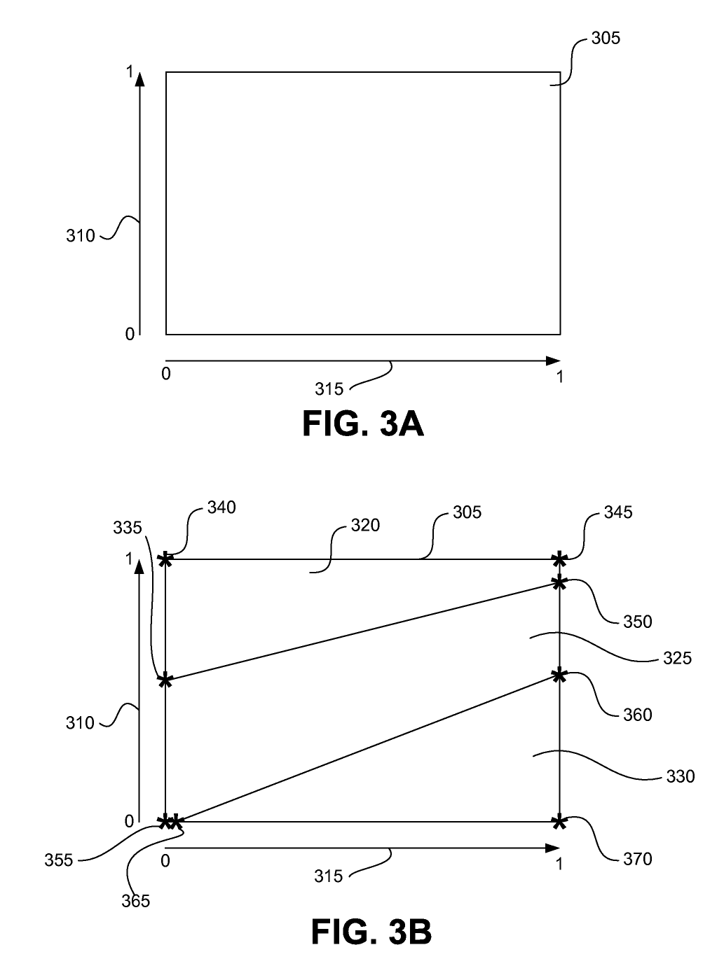

As discussed above a divided video may be associated with information that defines the location and/or shape of a portion of a frame within a frame. In one example, such information includes coordinate information. In one such example, coordinate information may be based on normalizing the dimensions of a frame such that the dimensions are measured from a value of zero to a value of one. In one exemplary aspect, a similar and/or proportionate system may also be used for a corresponding screen display and/or a corresponding video display region. FIGS. 3A and 3B illustrate one exemplary implementation of a normalized coordinate scale system for a frame 305. FIG. 3A shows frame 305 with a vertical normalized scale 310 having values from 0 to 1 and a horizontal scale 315 having values from 0 to 1.

In one example, such a coordinate system is used to define an exemplary division of frame 305 in three portions 320, 325, 330 shown in FIG. 3B. Portion 320 is defined by coordinates of {0.0000,0.5350}, {0.0000,1.0000}, {1.0000,1.0000}, {1.0000,0.9181}. Coordinates are given in {horizontal axis, vertical axis} form where each set of { } coordinates represents a vertex of the polygon portion. In other examples different coordinate formats may be utilized. Portion 325 has coordinates of {0.0000,0.5350}, {0.0000,0.0000}, {0.0286,0.0000}, {1.0000,0.5623}, {1.0000,0.9181}. Portion 330 has coordinates of {0.0286,0.0000}, {1.0000,0.0000}, {1.0000,0.5623}.

In FIG. 3B portion 320 has vertices at a location 335 (corresponding to {0.0000,0.5350}), a location 340 (corresponding to {0.0000,1.0000}), a location 345 (corresponding to {1.0000,1.0000}), and a location 350 (corresponding to {1.0000,0.9181}). Portion 325 has vertices at a location 355 (corresponding to {0.0000,0.0000}), location 335, location 350, a location 360 (corresponding to {1.0000,0.5623}), and a location 365 (corresponding to {0.0286,0.0000}). Portion 330 has vertices at location 365, location 360, and a location 370 (corresponding to {1.0000,0.0000}). Locations 335, 340, 345, 350, 355, 360, 365, 370 are shown in FIG. 3B with asterisks to assist with visualization. It should be understood that such asterisks may not be displayed in a display of frame 105.

One potential benefit of using a normalized scale coordinate system may be the ability to divide a frame of a video similarly in a situation where the frame has one set of unit dimensions, and a screen display and/or video display region has a different set of unit dimensions.

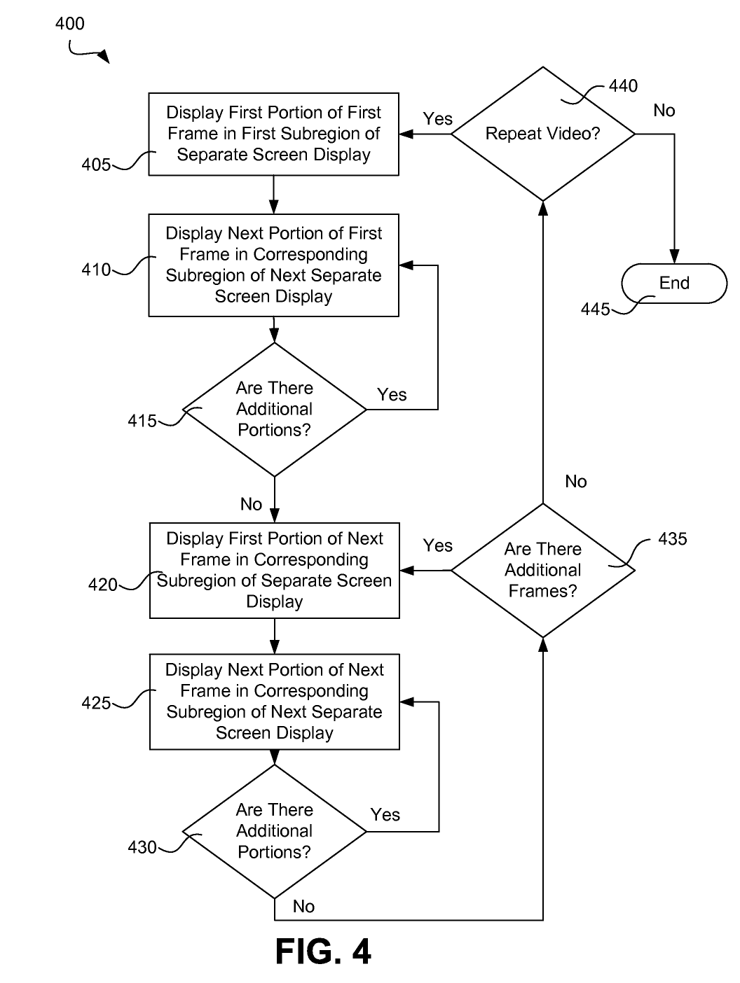

FIG. 4 illustrates one exemplary implementation of one embodiment of a method 400 for displaying a plurality of portions for each of a plurality of frames of a video. As discussed above, a video can have multiple frames. A divided video has at least some of the multiple frames divided into a plurality of portions. At step 405, a first portion of a first divided frame is displayed in a first subregion of a separate screen display. A screen display may be presented via a video display region of a display element associated with a computing device. Video display regions are discussed above. In one example, the first subregion of the area of the screen display corresponds to a like subregion of the frame from which the displayed portion was derived (e.g., in relative location and/or relative shape). In another example, the first subregion of the area of the screen display does not correspond to a like subregion of the frame from which the displayed portion was derived (e.g., in relative location and/or relative shape).

When a portion of a frame is displayed in a subregion of a screen display, the display of the other subregions of the screen display (e.g., those corresponding to the other portions of the frame) may be handled in a variety of ways. Example ways for handling the other subregions of a screen display that do not include a display of the selected portion include, but are not limited to, displaying a default set of pixels for the display element in one or more of the other subregions, not displaying any portion of the frame that is not the selected one portion for the particular screen display, displaying a substitute portion in one or more of the other subregions, displaying another portion, and any combinations thereof. In one example, when each portion of a frame is displayed in a corresponding subregion of a separate successive screen display, no other portions of the frame are displayed in the other subregions of the screen display. In another example, when each portion of a frame is displayed in a corresponding subregion of a separate successive screen display, one or more substitute portions are displayed in the other subregions of the screen display.

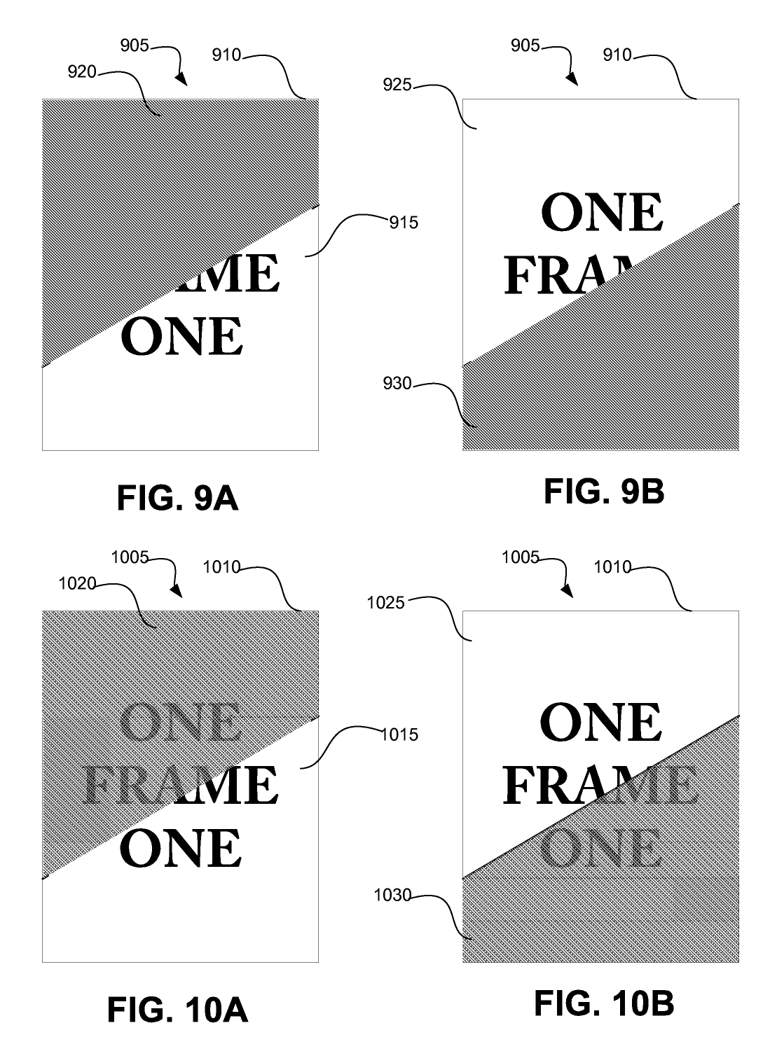

Examples of a substitute portion include, but are not limited to, a greyscale portion, a black portion, a white portion, a colored portion, a blurred version of the original portion, a version of the original portion having a filter applied, a version of the original portion having one or more image parameters modified, a user-defined substitute displayable element (e.g., defined and/or selected via an interface provided to a user), and any combinations thereof. Examples of an image parameter include, but are not limited to, a picture quality parameter, an image exposure parameter, an image lighting parameter, an image aperture parameter, an image zoom parameter, an image size parameter, an image color, an image contrast, an image luminance, and any combinations thereof. In one example, a substitute portion is a displayable portion in which data is provided to a display element of a computing device to display that data in place of an original portion. Additional examples of substitute portions are discussed further below with respect to FIGS. 9A, 9B, 10A, 10B and other locations.

A substitute portion may be in the form of machine-displayable information stored in a memory of a computing device. In one example, one or more substitute portions are stored on a computing device used to display the one or more substitute portions. A substitute portion may be provided to a computing device used for display of the substitute portion by another computing device. A substitute portion may be created by a computing device (e.g., a sending computing device, an intermediate computing device, a recipient computing device used to display the substitute portion). In one example, a substitute portion is created using machine-executable instructions and modification of a portion of a frame of a subregion of a frame corresponding to a subregion of display for the substitute portion. A substitute portion may be created automatically (e.g., using machine executable instructions and a processing element).

In one exemplary alternate implementation, if there are three or more portions of a frame, more than one portion may be displayed at the same time in a separate successive screen display. In one example, when a first portion of a frame is displayed in a first subregion of a screen display at least one other subregion of the screen display does not have a display of a corresponding other portion of the frame. In one such example, one other subregion of the screen display does not have a display of a corresponding other portion of the frame and successive screen displays have alternate subregions without a portion of the frame displayed. In another such example, two or more portions are displayed in corresponding subregions, more than one other subregion of the screen display does not have a display of a corresponding other portion of the frame, and successive screen displays have alternating subregions without a portion displayed. Other examples of variations are possible and should be understood from the disclosure herein. Such examples in which at least one of the portions is not displayed at the same time as one or more other portions can represent the separated display of portions (e.g., where each frame of a plurality of frames is displayed in at least two separate screen displays, each with at least one portion of a frame not displayed).

At step 410, a next portion of the first frame is displayed in a corresponding subregion of a separate screen display. At step 415 if additional portions of the first frame exist, step 410 is repeated. If additional portions of the first frame do not exist, the method proceeds to step 420. For example, with reference to FIG. 2D, portion 214 is displayed at step 405, portion 244 is displayed at step 410, and portion 245 is displayed at step 415 (as a repeat of step 410). With no additional portions for frame 202, the second iteration of step 415 proceeds to step 420.

At step 420, a first portion of a next frame is displayed in a corresponding subregion of a separate screen display. At step 425, a next portion of that frame is displayed in a corresponding subregion of a separate screen display. At step 430, if additional portions of the frame exist, step 425 is repeated. If additional portions of the frame do not exist, the method proceeds to step 435. For example, with further reference to FIG. 2D, portion 224 is displayed at step 420, portion 250 is displayed at step 425, and portion 251 is displayed at step 430 (as a repeat of step 425). With no additional portions for frame 206, the second iteration of step 430 proceeds to step 435.

At step 435, if additional frames exist, the method proceeds to repeat at step 420. If additional frames do not exist, the method proceeds to step 440. At step 440, if the video is to be repeated, the method proceeds to repeat at step 405. If the video is not to be repeated, the method proceeds to an end at 445. For example, with further reference to FIG. 2D, portion 234 is displayed at a repeat of step 420, portion 256 is displayed at a next iteration of step 425, and portion 257 is displayed at a next iteration of step 430 (as a repeat of step 425). With no additional portions for frame 206, the next iteration of step 430 proceeds to step 435. At step 435, if additional frames exist in video 200, the process would repeat at step 420. At step 435, if no additional frames exist in video 200, the process would proceed to step 440 (at which the process would end at step 445 if it were not to repeat display of video 200).

Prior to display of a portion of a frame of a video to a user, the portion may be changed by having an image parameter of the portion of the image modified. An image parameter can be modified in a variety of ways. Ways of modifying an image parameter include, but are not limited to, providing a user of a computing device with an interface for providing an instruction for modifying an image parameter, automatically modifying an image parameter, modifying an image parameter based on a predetermined modification, and any combinations thereof. An image parameter of a portion of a frame of a video may be modified at any time prior to a display of the portion in which it is desired to have the image parameter changed. Example times for modifying an image parameter of a portion of a frame of a video include, but are not limited to, at a time prior to a portion of a frame of a video being transferred from a sending computing device to a receiving computing device (e.g., via providing a sending user with an interface for making the modification prior to transmission from the sending computing device), at a time after a portion of a frame of a video is transferred from a sending computing device and before the portion of a frame of a video is transferred to a target viewing computing device (e.g., automatic modification at an intermediate computing device, such as a server computer, prior to transmission to an intended recipient), at a time after a portion of a frame of a video is received at a target viewing computing device (e.g., automatic modification performed by machine executable instructions and processing circuitry on the target viewing computing device prior to display of the portion of a frame of a video), and any combinations thereof. A predetermined image modification is a particular modification that is known and desired (e.g., by one or more designers of a system that allows one or more of the functionalities of displaying a divided video, dividing a video, and/or other implementation according to the current disclosure).

As discussed above, one example of a computing device that may be utilized in one or more of the implementations of a method of the present disclosure is a handheld computing device. FIG. 5 illustrates one example of a portable handheld computing device in the form of a smartphone 500. Smartphone 500 includes a body 505, a keyboard user input element 510, and a display element 515. Display element 515 may be a touch screen to provide a user with additional input interface capabilities. A computing device, such as smartphone 500, may be used in a variety of ways with respect to any of the methods described herein. Exemplary ways to utilize smartphone 500 (or another computing device) include, but are not limited to, acquiring a video; storing a video, one or more portions of a video, and/or a divided video; dividing a video; transmitting a video, one or more portions of a video, and/or a divided video to another computing device; receiving a video, one or more portions of a video, and/or a divided video from another computing device; displaying each portion of a plurality of portions of a frame of a video separately, displaying each portion of a plurality of portions of a plurality of frames in separate successive screen displays; modifying an image parameter of one or more portions of a frame; providing an interface to a user of a computing device; receiving an instruction (and/or other input) from a user of a computing device; and any combinations thereof.

FIG. 6 illustrates another example of a portable handheld computing device in the form of a smartphone 600. Smartphone 600 includes a body 605, a button user input element 610, and a display element 615. Display element 615 may be a touch screen to provide a user with additional input interface capabilities. A computing device, such as smartphone 600, may be used in a variety of ways with respect to any of the methods described herein.

FIG. 7 illustrates one example diagrammatic representation of one implementation of a computing device 700. Computing device 700 includes a processing element 705, a memory 710, a display generator 715, a user input 720, a networking element 725, and a power supply 730. Processing element 705 includes circuitry and/or machine-executable instructions (e.g., in the form of firmware stored within a memory element included with and/or associated with processing element 705) for executing instructions for completing one or more tasks (e.g., tasks associated with one or more of the implementations, methodologies, features, aspects, and/or examples described herein). Examples of a processing element include, but are not limited to, a microprocessor, a microcontroller, one or more circuit elements capable of executing a machine-executable instruction, and any combinations thereof.

Memory 710 may be any device capable of storing data (e.g., data representing a video, a divided video, and/or one or more portions of a frame; data representing information related to the division of one or more frames), machine-executable instructions, and/or other information related to one or more of the implementations, methodologies, features, aspects, and/or examples described herein. A memory, such as memory 710, may include a machine-readable hardware storage medium. Examples of a memory include, but are not limited to, a solid state memory, a flash memory, a random access memory (e.g., a static RAM “SRAM”, a dynamic RAM “DRAM”, etc.), magnetic memory (e.g., a hard disk, a tape, a floppy disk, etc.), an optical memory (e.g., a compact disc (CD), a digital video disc (DVD), a Blu-ray disc (BD); a readable, writeable, and/or re-writable disc, etc.), a read only memory (ROM), a programmable read-only memory (PROM), a field programmable read-only memory (FPROM), a one-time programmable non-volatile memory (OTP NVM), an erasable programmable read-only memory (EPROM), an electrically erasable programmable read-only memory (EEPROM), and any combinations thereof. Examples of a flash memory include, but are not limited to, a memory card (e.g., a MultiMediaCard (MMC), a secure digital (SD), a compact flash (CF), etc.), a USB flash drive, another flash memory, and any combinations thereof.

A memory may be removable from device 700. A memory, such as memory 710, may include and/or be associated with a memory access device. For example, a memory may include a medium for storage and an access device including one or more circuitry and/or other components for reading from and/or writing to the medium. In one such example, a memory includes a disc drive for reading an optical disc. In another example, a computing device may include a port (e.g., a Universal Serial Bus (USB) port) for accepting a memory component (e.g., a removable flash USB memory device).

A memory, such as memory 710, may include any information stored thereon. Examples of information that may be stored via a memory associated with a computing device include, but are not limited to, a video, a still image, a divided video, a divided image, one or more portions of a frame of a video, one or more portions of a still image, segment information, machine-executable instructions embodying any one or more of the aspects and/or methodologies of the present disclosure (e.g., instructions for displaying a divided video, instructions for providing an interface, etc.), an operating system for a computing device, an application program a program module, program data, a basic input/output system (BIOS) including basic routines that help to transfer information between components of a computing device, and any combinations thereof.

In one example, a video is stored on memory 710 after acquisition by a camera associated with computing device 700. In another example, a video is stored on memory 710 after acquisition via electronic transfer to computing device 700. Examples of electronic transfer include, but are not limited to, attachment to an electronic message (e.g., an email, an SMS/MMS message, a Snapchat message, a Facebook message, etc.), downloaded/saved from an online/Internet posting, transfer from a memory element removable from device 700, wireless transfer from another computing device, wired transfer from another computing device, and any combinations thereof.

Device 700 includes camera 715 connected to processing element 705 (and other components). Camera 715 may be utilized for acquiring one or more videos for use with one or more of the implementations, embodiments, examples, etc. of the current disclosure. Examples of a camera include, but are not limited to, a still image camera, a video camera, and any combinations thereof.

Display component 720 is connected to processing element 705 for providing a display according to any one or more of the implementations, examples, aspects, etc. of the current disclosure (e.g., providing an interface, displaying separated display screens for each of a plurality of portions of a frame, etc.). A display component 715 may include a display element, a driver circuitry, display adapter, a display generator, machine-executable instructions stored in a memory for execution by a processing element for displaying still and/or moving images on a screen, and/or other circuitry for generating one or more displayable images for display via a display element. Example display elements are discussed above. In one example, a display element is integrated with device 700 (e.g., a built-in LCD touch screen). In another example, a display element is associated with device 700 in a different fashion (e.g., an external LCD panel connected via a display adapter of display component 715).

User input 725 is configured to allow a user to input one or more commands, instructions, and/or other information to computing device 700. For example, user input 725 is connected to processing element 705 (and optionally to other components directly or indirectly via processing element 705) to allow a user to interface with computing device 700 (e.g., to actuate camera 715, to input instructions for dividing a video, to input instructions for designating a recipient of a video, and/or to perform one or more other aspects and/or methodologies of the present disclosure). Examples of a user input include, but are not limited to, a keyboard, a keypad, a screen displayable input (e.g., a screen displayable keyboard), a button, a toggle, a microphone (e.g., for receiving audio instructions), a pointing device, a joystick, a gamepad, a cursor control device (e.g., a mouse), a touchpad, an optical scanner, a video/image capture device (e.g., a camera), a touch screen of a display element, a pen device (e.g., a pen that interacts with a touch screen and/or a touchpad), and any combination thereof. It is noted that camera 715 and/or a touch screen of a display element of display component 720 may function also as an input element. It is also contemplated that one or more commands, data, and/or other information may be input to a computing device via a data transfer over a network and/or via a memory device (e.g., a removable memory device). A user input, such as user input 725, may be connected to computing device 700 via an external connector (e.g., an interface port).

External interface element 730 includes circuitry and/or machine-executable instructions (e.g., in the form of firmware stored within a memory element included with and/or associated with interface element 730) for communicating with one or more additional computing devices and/or connecting an external device to computing device 700. An external interface element, such as element 730, may include one or more external ports. In another example, an external interface element includes an antenna element for assisting with wireless communication. Examples of an external interface element include, but are not limited to, a network adapter, a Small Computer System Interface (SCSI), an advanced technology attachment interface (ATA), a serial ATA interface (SATA), an Industry Standard Architecture (ISA) interface, an extended ISA interface, a Peripheral Component Interface (PCI), a Universal Serial Bus (USB), an IEEE 1394 interface (FIREWIRE), and any combinations thereof. A network adapter includes circuitry and/or machine-executable instructions configured to connect a computing device, such as computing device 700, to a network.

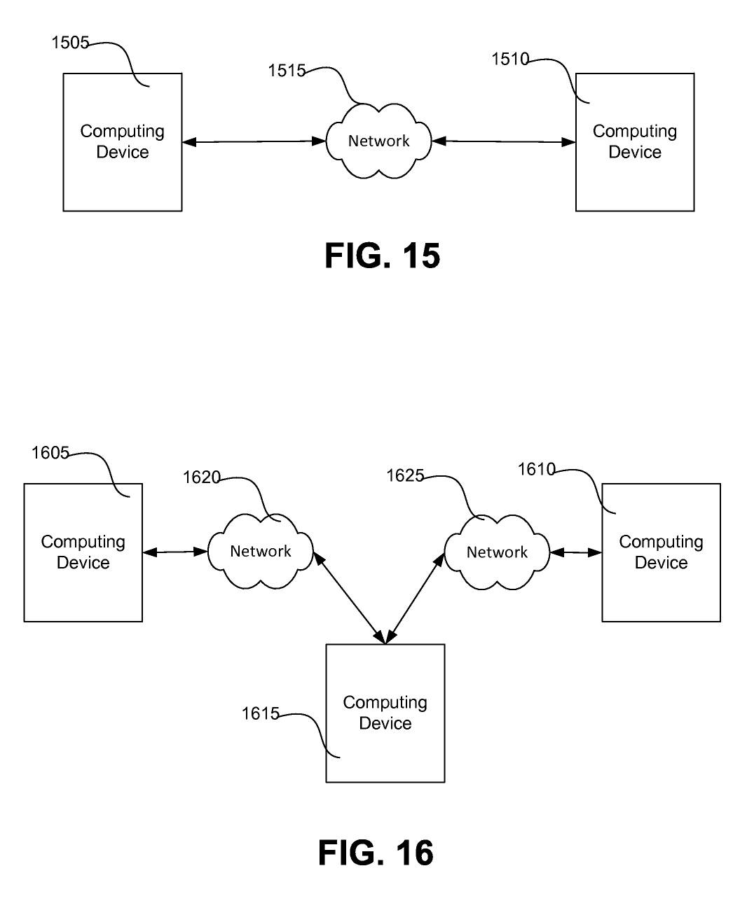

A network is a way for connecting two or more computing devices to each other for communicating information (e.g., data, machine-executable instructions, image files, video files, electronic messages, etc.). Examples of a network include, but are not limited to, a wide area network (e.g., the Internet, an enterprise network), a local area network (e.g., a network associated with an office, a building, a campus or other relatively small geographic space), a short distance network connection, a telephone network, a data network associated with a telephone/voice provider (e.g., a mobile communications provider data and/or voice network), another data network, a direct connection between two computing devices (e.g., a peer-to-peer connection), a proprietary service-provider network (e.g., a cable provider network), a wired connection, a wireless connection (e.g., a Bluetooth connection, a Wireless Fidelity (Wi-Fi) connection (such as an IEEE 802.11 connection), a Worldwide Interoperability for Microwave Access connection (WiMAX) (such as an IEEE 802.16 connection), a Global System for Mobile Communications connection (GSM), a Personal Communications Service (PCS) connection, a Code Division Multiplex Access connection (CDMA), and any combinations thereof. A network may employ one or more wired, one or more wireless, and/or one or more other modes of communication. A network may include any number of network segment types and/or network segments. In one example, a network connection between two computing devices may include a Wi-Fi connection between a sending computing device and a local router, an Internet Service Provider (ISP) owned network connecting the local router to the Internet, an Internet network (e.g., itself potentially having multiple network segments) connection connecting to one or more server computing devices and also to a wireless network (e.g., mobile phone) provider of a recipient computing device, and a telephone-service-provider network connecting the Internet to the recipient computing device. Examples of use of a network for transmitting a video, a divided video, and/or one or more portions of one or more frames of a video are discussed further below (e.g., with respect to FIGS. 15 and 16).

Power supply 730 is shown connected to other components of computing device 705 to provide power for operation of each component. Examples of a power supply include, but are not limited to, an internal power supply, an external power supply, a battery, a fuel cell, a connection to an alternating current power supply (e.g., a wall outlet, a power adapter, etc.), a connection to a direct current power supply (e.g., a wall outlet, a power adapter, etc.), and any combinations thereof.

Components of device 700 (processing element 705, memory 710, camera 715, display component 720, user input 725, interface element 730, power supply 735) are shown as single components. A computing device may include multiple components of the same type. A function of any one component may be performed by any number of the same components and/or in conjunction with another component. For example, it is contemplated that the functionality of any two or more of processing element 705, memory 710, camera 715, display component 720, user input 725, interface element 730, power supply 735, and another component of a computing device may be combined in an integrated circuit. In one such example, a processor (e.g., processing element 705) may include a memory for storing one or more machine executable instructions for performing one or more aspects and/or methodologies of the present disclosure. Functionality of any one or more components may also be distributed across multiple computing devices. Such distribution may be in different geographic locations (e.g., connected via a network). Components of device 700 are shown as internal components to device 700. A component of a computing device, such as device 700, may be associated with the computing device in a way other than by being internally connected.

Components of computing device 700 are shown connected to other components. Examples of ways to connect components of a computing device include, but are not limited to, a bus, a component connection interface, another type of connection, and/or any combinations thereof. Examples of a bus and/or component connection interface include, but are not limited to, a memory bus, a memory controller, a peripheral bus, a local bus, a parallel bus, a serial bus, a SCSI interface, an ATA interface, an SATA interface, an ISA interface, a PCI interface, a USB interface, a FIREWIRE interface, and any combinations thereof. Various bus architectures are known. Select connections and components in device 700 are shown. For clarity, other connections and various other well-known components (e.g., an audio speaker, a printer, have been omitted and may be included in a computing device. Additionally, a computing device may omit in certain implementations one or more of the shown components.

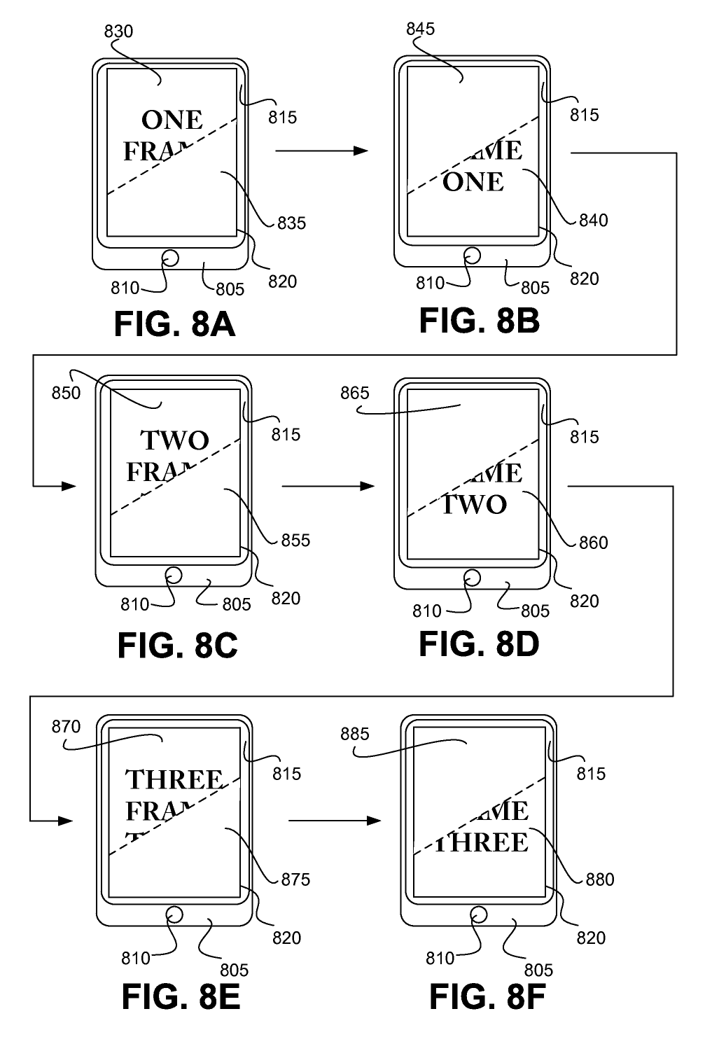

FIGS. 8A to 8F illustrate one exemplary implementation of a display of a plurality of portions of a plurality of frames of a video (i.e., a divided video) via a computing device. For the sake of brevity, some of the details, concepts, aspects, features, characteristics, examples, and/or alternatives discussed with respect to other implementations in this disclosure are not repeated in the discussion of FIGS. 8A to 8F. Any one or more of the like details, concepts, aspects, features, characteristics, examples, and alternatives may apply similarly here, except where noted.

Computing device 805 (here shown as an example smartphone implementation) includes a user input 810. Also, device 805 includes a display element 815 (e.g., a touch screen LCD display). Display element 815 is shown displaying a video display region 820 having an area inside the perimeter of the region. In this example, video display region 820 is shown having a rectangular shape representative of a video to be displayed.

In FIG. 8A, a portion 830 of a first frame of a video is displayed in a subregion of video display region 820. In this example, the subregion corresponds to the location of portion 830 in the video. A substitute portion 835 is displayed in the subregion(s) of the video display region that do not correspond to portion 830 (e.g., the subregion that corresponds to one or more additional portions of the first frame of the video).

FIG. 8B illustrates the separated display of a portion 840 of the first frame via device 805 in a subregion of video display region 820 that corresponds to the location of portion 840 in the first frame. A substitute portion 845 is displayed in the subregion of the video display region corresponding to portion 830.

FIG. 8C illustrates the separated display of a portion 850 of a second frame of the video via device 805 in a subregion of video display region 820 that corresponds to the location of portion 850 in the second frame. A substitute portion 855 is displayed in the subregion of the video display region that do not correspond to the location of portion 850 (e.g., the subregion that corresponds to one or more additional portions of the first frame of the video).

FIG. 8D illustrates the separated display of a portion 860 of the second frame via device 805 in a subregion of video display region 820 that corresponds to the location of portion 860 in the second frame. A substitute portion 865 is displayed in the subregion of the video display region corresponding to portion 850.

FIG. 8E illustrates the separated display of a portion 870 of a third frame of the video via device 805 in a subregion of video display region 820 that corresponds to the location of portion 870 in the third frame. A substitute portion 875 is displayed in the subregion of the video display region that do not correspond to the location of portion 870 (e.g., the subregion that corresponds to one or more additional portions of the first frame of the video).

FIG. 8F illustrates the separated display of a portion 880 of the third frame via device 805 in a subregion of video display region 820 that corresponds to the location of portion 880 in the third frame. A substitute portion 885 is displayed in the subregion of the video display region corresponding to portion 870.

Portions 830, 840, 850, 860, 870, and 880 are not displayed at the same time. Portions 830, 840, 850, 860, 870, and 880 are displayed in succession in an order as shown by the arrows between the figures. In one example, this order (portions of the first frame, portions of the second frame, portions of the third frame, etc.) corresponds to the order of frames in the video from which the portions were derived. In another example, this order (portions of the first frame, portions of the second frame, portions of the third frame, etc.) does not corresponds to the order of frames in the video from which the portions were derived. As noted above, the dashed lines in the displays of each of FIGS. 8A to 8F are an optional element. Substitute portions 835, 845, 855, 865, 875, and 885 are shown as white blank polygons. In another example, another substitute portion may be used in place of a white blank polygon. Examples of other substitute portions are discussed above. In another example, a non-display (e.g., a default state for no data) of display element 815 may be used in place of a white blank polygon.

FIGS. 9A and 9B show one example of a substitute portion used in separated display of portions of a frame of a video. FIG. 9A illustrates a video display region 905 having an area bounded by a perimeter 910. A portion 915 of a frame is displayed in a subregion of the area that corresponds to portion 915. A substitute portion 920 is displayed in a subregion of the area that corresponds to portions other than portion 915. Substitute portion 920 is shown as a greyscale polygon-shaped portion. FIG. 9B illustrates video display region 905 with a portion 925 of the frame displayed in a subregion of the area that corresponds to portion 925. A substitute portion 930 is displayed in a subregion of the area that corresponds to portions other than portion 925 (i.e., the subregion corresponding to portion 915). Substitute portion 930 is shown as a greyscale polygon-shaped portion.

FIGS. 10A and 10B show another example of a substitute portion used in separated display of portions of a frame of a video. FIG. 10A illustrates a video display region 1005 having an area bounded by a perimeter 1010. A portion 1015 of a frame is displayed in a subregion of the area that corresponds to portion 1015. A substitute portion 1020 is displayed in a subregion of the area that corresponds to portions other than portion 1015. FIG. 10B illustrates video display region 1005 with a portion 1025 displayed in a subregion of the area that corresponds to portion 1025. A substitute portion 1030 is displayed in a subregion of the area that corresponds to portions other than portion 1025 (i.e., the subregion corresponding to portion 1015). Substitute portion 1020 is shown as a blurred polygon-shaped version of portion 1025. Substitute portion 1030 is shown as a blurred polygon-shaped version of portion 1015.

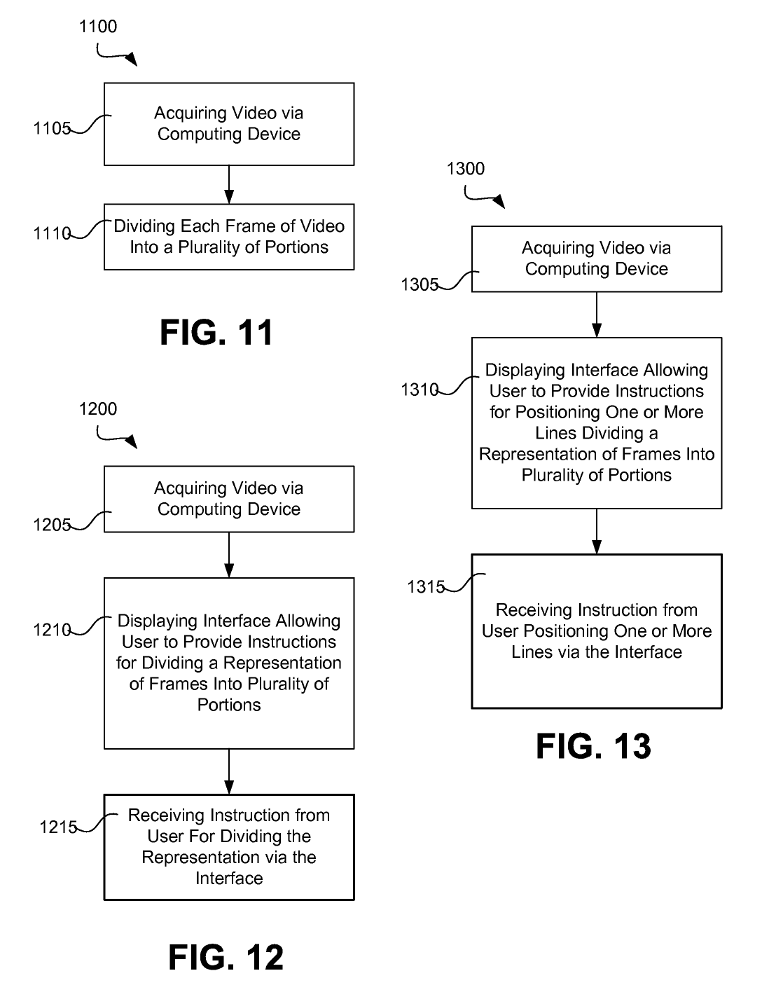

FIG. 11 illustrates one exemplary implementation of a method 1100 of dividing a video via dividing each frame of at least a set of frames of the plurality of frames of a video into a plurality of portions. For the sake of brevity, some of the details, concepts, aspects, features, characteristics, examples, and/or alternatives discussed with respect to other implementations in this disclosure (e.g., related to the division of a frame into a plurality of portions) are not repeated in the discussion of FIG. 11. Any one or more of the like details, concepts, aspects, features, characteristics, examples, and alternatives may apply similarly here, except where noted. At step 1105, a video is acquired via a computing device.

Acquisition of a video can occur in a variety of ways. Example ways to acquire a video include, but are not limited to, using a camera built into a computing device to capture a video, using a camera associated with a computing device to capture a video, accessing a video stored on a memory element of a computing device, accessing a video stored on a memory element associated with a computing device, receiving a video over a network connection (e.g., as an attachment to an electronic message, as a download from an Internet posting, etc.), and any combinations thereof. In one example, a video is captured using a camera and stored (e.g., temporarily in RAM or other volatile memory, as a video file in non-volatile memory, etc.) in a memory element of a computing device from where it is acquired. In another example, a video previously saved as a video file on a memory element of a computing device is acquired by accessing the image file.

At step 1110, each frame of at least a set of the frames of a video is divided into a plurality of portions. Any number of the frames of a video may be divided. In one example, less than all of the frames of a video are divided. In another example, all of the frames of a video are divided. A set of frames of a video may be consecutive frames of a video, non-consecutive frames of a video, and/or a combination of consecutive and non-consecutive frames.

The dividing of a frame into a plurality of portions (e.g., an automated dividing, a dividing via a user interface, etc.) can occur at any of a variety of computing devices and/or times with respect to the acquisition of the video. In one example, a video is acquired via a computing device and the dividing occurs at the same computing device. In another example, a video is acquired via a computing device and the dividing occurs at the same computing device prior to transmitting the divided video to another computing device. In still another example, a video is acquired via a computing device and transmitted to another computing device at which the dividing occurs (e.g., at an intermediate server computing device, at a recipient computing device).

How the specific portions of a frame of a video are determined by a user and/or by an automated function may vary based on a desired outcome. Example considerations for determining how a frame of a video is divided include, but are not limited to, a random placement, an entertainment purpose, ensuring separation of identifying information that in itself identifies a subject included in the frame from other aspects of the frame (e.g., via division such that identifying information is in one portion and other aspects are included in one or more other portions), a privacy concern, locating all or a part of a face of a subject included in the video in one portion and other aspects of the video in one or more other portions, preventing screen capture of two or more aspects of a video (e.g., via placing the two or more aspects in separate portions), another reason of a user, another reason of a system designer, and any combinations thereof.

As discussed above, each portion of a divided frame corresponds to a subregion of the area of the original frame. During a later separated display of the portions of a frame, corresponding subregion information may be utilized. For example, a display of a portion of a frame may position the portion such that it is located on the display in a subregion of the display that correlates to the original subregion of the frame. In one such example, each portion can be positioned in the display such that the overall impression from the separated views of all portions may appear similar to the original frame (e.g., successive display of multiple portions of multiple frames may appear similar to a viewer as the original video without division of frames). In other examples, display of one or more portions may position a portion in a subregion of the video display region that does not correlate with the original position of the subregion of the original frame from where the portion derived.

As discussed above, one or more portions of a divided frame may have an image parameter modified. Example image parameters are discussed above. In one example, an interface can be provided to a user of a computing device for modifying one or more image parameters of one or more portions of a video. Such an interface can provide the user with an ability to input instructions for modifying an image parameter. A user may utilize an input element to provide such an instruction via the interface. Such instructions may be received via the computing device. In another example, one or more image parameters of one or more portions may be automatically modified (e.g., via a sending computing device, via a recipient computing device, and/or via an intermediate computing device).

Additional visual information may be added to a video, a frame, and/or one or more portions of a divided frame. Examples of additional visual information include, but are not limited to, a textual information, a graphical information, and any combinations thereof. In one example, one or more additional visual information elements is added to a video, frame, and/or portion of a frame prior to the video being divided such that the one or more additional visual information elements may be divided along with the video according to one or more of the implementations discussed herein for dividing a video. In another example, one or more additional visual information elements is added to a video, frame, and/or portion of a frame after the video is divided. A user interface may be provided at a computing device to allow a user to add one or more additional visual information. A user may utilize an input element to provide an instruction regarding an additional visual information via the interface. An instruction may be received via the computing device. In another example, one or more additional visual information is added automatically (e.g., via a sending computing device, via a recipient computing device, and/or via an intermediate computing device)

As discussed above, an interface may also be provided that allows a user to provide an instruction for defining a characteristic of one or more substitute portions. A user may utilize an input element to provide such an instruction via the interface. An instruction may be received via the computing device.

A divided video, regardless of which process is used to divide the video, can be handled in a variety of ways after it has been divided. Example ways for handling a divided video include, but are not limited to, displaying one or more of the divided portions of one or more frames on the same computing device used to divide the video, displaying one or more of the divided portions of one or more frames on a computing device that is different from the computing device used to divide the video, transmitting the divided video from the computing device used to divide the video to a second computing device, storing the divided video on a memory element (e.g., a memory element part of the computing device used to divide the video, a memory element associated (e.g., a cloud storage device) with the computing device used to divide the video, a memory element of a computing device not used to divide the video, etc.), uploading a divided video to a social networking service (e.g., Facebook, Instagram, etc.), and any combinations thereof. Transmission of a divided video can occur shortly after the dividing and/or at a later time. Examples of a transmission include, but are not limited to, uploading the divided video to a computing device of a service provider affiliated with the dividing of the video (e.g., a service provider that provided machine-executable instructions, such as in the form of an “app” and/or webservice, for dividing the video), uploading the divided video to a computing device of a social network provider (e.g., Facebook, Instagram, etc.), attaching the divided video to an electronic message (e.g., an e-mail, an electronic message specifically designed to transfer the divided video, etc.), transmitting the divided video to a computing device of an intended recipient of the divided video, transmitting the divided video to an intermediate computing device (e.g., a server computing device), and any combinations thereof.

FIG. 12 illustrates another exemplary implementation of a method 1200 of dividing a video into a plurality of portions. Exemplary details, concepts, aspects, features, characteristics, examples, and/or alternatives for portions of a frame, interfaces for dividing a video, and the division of frames are discussed elsewhere in the current disclosure (e.g., with respect to FIGS. 1A to 1C, 2A to 2D, 3A, 3B, 11) and may be applicable where appropriate in this implementation except where expressly described otherwise. At step 1205, a video is acquired via a computing device.

At step 1210, an interface is provided to a user of the computing device. The interface is configured to allow the user to provide instructions for dividing each of at least a set of frames of the video into a plurality of portions. One or more representations of one or more frames is provided via the interface to assist division into a plurality of portions. Example representations are discussed above with respect to FIGS. 1A to 1C.

A user may interact with the interface to provide the instructions for dividing. In one example, one or more input elements of a computing device may be utilized to provide instructions for dividing to a computing device. The computing device receives the instructions from the user and may utilize the instructions for dividing the video (e.g., at the computing device prior to transmission to another computing device, at another computing device after transmission to the other computing device, etc.). Example input elements are discussed above with respect to FIG. 7. In one example, a user interacts with the interface including actuation of a touch screen of a display element to provide instructions for dividing a frame of a video and the computing device receives the instructions via the actuation of the touch screen. Other example user input element actuations and combinations of actuations will be understood and applicable depending on the particular computing device, interface, display element, etc.

One or more additional interfaces (e.g., to allow a user to provide an instruction for modification of an image parameter of one or more portions of a frame, to allow a user to define one or more characteristics of one or more substitute portions, and/or to allow a user to provide an instruction for adding additional visual information to a video, a frame, and/or one or more portions of a divided frame) may be provided. In one example, one or more interfaces together provide the functionality of a plurality of interfaces. In another example, each interface is designed to receive one type of instruction from a user.

At step 1215, an instruction for dividing a representation of one or more frames is received via the interface. The received instruction can be utilized to divide one or more of the frames of the video into a plurality of portions. For example, one or more locations for division of a representation of one or more frames may be received. The one or more locations for division of the representation can then be utilized to divide each of the one or more frames represented by the representation at one or more locations that correspond to the one or more locations for division of the representation. In one example, a plurality of portions is defined by positioning one or more lines via an interface. In another example, a plurality of portions is defined by defining a plurality of polygon-shaped portions.

FIG. 13 illustrates yet another exemplary implementation of a method 1300 of dividing a video into a plurality of portions. Exemplary details, concepts, aspects, features, characteristics, examples, and/or alternatives for portions of a frame, interfaces for dividing a video, and the division of frames (e.g., using one or more lines) are discussed above (e.g., with respect to FIGS. 1A to 1C, 2A to 2D, 3A, 3B, 11, 12) and may be applicable where appropriate in this implementation except where expressly described otherwise. At step 1305, a video is acquired via a computing device. Aspects, features, and examples of acquiring a video are discussed above (e.g., with respect to method 1100 of FIG. 11).

At step 1310, an interface is provided to a user of the computing device. The interface is configured to allow the user to provide instructions for positioning one or more lines dividing one or more representations of at least a set of frames of the video into a plurality of portions. Example representations are discussed above with respect to FIGS. 1A to 1C. Example ways to allow a user to position a line on an image include, but are not limited to, accepting instruction from a user via a user input device associated with (e.g., directly part of and/or connected to) a computing device, displaying an image via a display element and positioning a line across a part of the image, displaying an image via a display element and displaying a line via the same display element (the line having changeable position and/or length), and any combinations thereof.

At step 1315, an instruction for positioning one or more lines is received for dividing one or more frames into one or more portions. The received instruction for positioning one or more lines can be utilized to divide one or more of the frames of the video into a plurality of portions. For example, the location of one or more lines positioned via the representation of one or more frames may be received. The one or more lines positioned for division of the representation can then be utilized to divide each of the one or more frames represented by the representation at the location(s) that correspond to the one or more lines positioned via the representation.

One or more additional interfaces (e.g., to allow a user to provide an instruction for modification of an image parameter of one or more portions of a frame, to allow a user to define one or more characteristics of one or more substitute portions, and/or to allow a user to provide an instruction for adding additional visual information to a video, a frame, and/or one or more portions of a divided frame) may be provided. In one example, one or more interfaces together provide the functionality of a plurality of interfaces. In another example, each interface is designed to receive one type of instruction from a user.

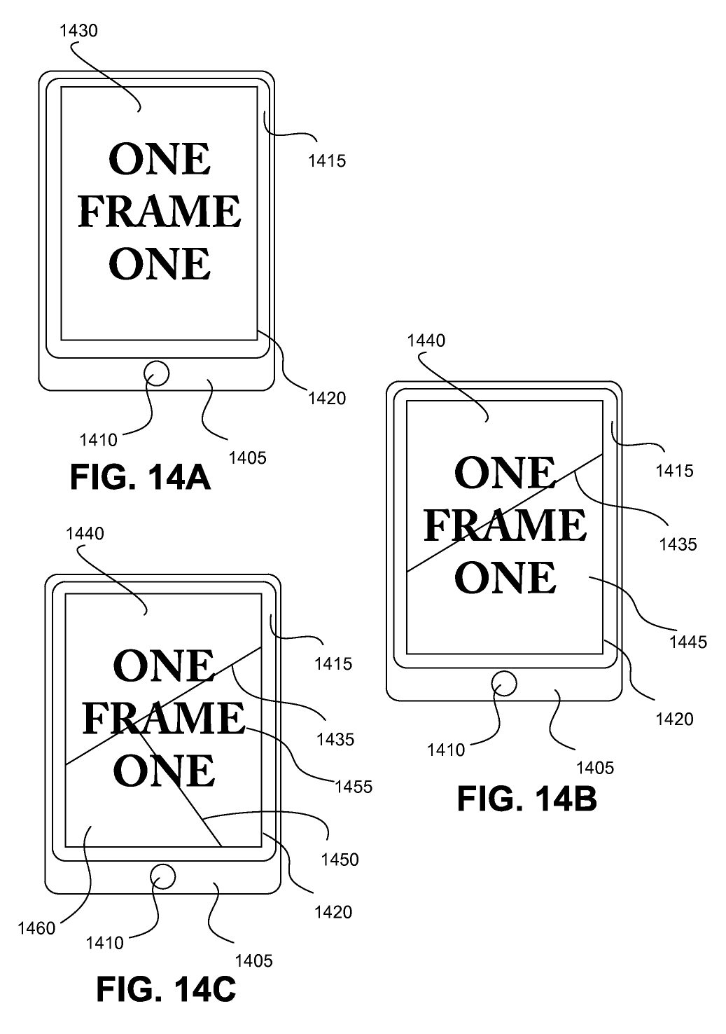

FIGS. 14A to 14C illustrate one exemplary implementation of an interface for dividing a video. FIG. 14A shows a computing device 1405 having an input element 1410 and a display screen of a display element 1415. An interface 1420 is provided via the display element 1415. In one example, display element 1415 includes a touch screen capability that can provide a user an ability to provide one or more inputs to computing device 1405. Interface 1420 is shown displaying a representation 1430 of one or more frames of a video. Interface 1420 is configured (e.g., via machine-executable instructions, interaction with display element 1415, and interaction with one or more user inputs, such as input 1410 and/or a touch screen capability of display element 1415) to allow a user of computing device 1405 to position one or more lines to divide representation

FIG. 14B shows a line 1435 positioned via interface 1420 to divide representation 1430 into a portion 1440 and a portion 1445. Line 1435 is shown connecting two edges of representation 1430. FIG. 14C shows a line 1450 positioned via interface 1420 to divide portion 1445 into a portion 1455 and a portion 1460. A line positioned at a division of two or more portions, such as line 1435 and/or line 1450, may extend beyond an edge of a frame and/or beyond an intersection of two lines in a display of an interface (e.g., even though such extension may not be necessary to define a division of a frame).

As discussed above, an acquired video and/or a divided video of any one of the various embodiment, implementations, and/or examples disclosed herein may be transmitted from one computer (e.g., a sending computing device) to another computing device (e.g., an intermediate computing device, such as a server computer, and/or a recipient computing device). Transmission from one computing device to another computing device may occur over a network.

FIG. 15 illustrates one example of a networking environment including a first computing device 1505 connected to a second computing device 1510 via a network 1515. Examples of a computing device are discussed above. Each of computing devices 1505 and 1510 may include a networking element for allowing connection to network 1515.

As discussed in the various examples above, a video may be acquired via computing device 1505. In one example, the video may be divided at computing device 1505 prior to transmitting from computing device 1505. In another example, the video may be divided at computing device 1510 (e.g., prior to display of the video via computing device 1510).

A video, a divided video, one or more portions of one or more frames of a video, segment information detailing a division of one or more frames of a video, and/or other information may be transmitted from computing device 1505 to computing device 1510 over network 1515. In one example, a divided video (e.g., as a plurality of portions each as separate files, as a video file and segment information detailing the division into a plurality of portions, etc.) is transmitted from computing device 1505 as part of a single transmission (e.g., as one set of data transfer). In another example, different portions of a divided video are transmitted separately from computing device 1505 as separate files. In yet another example, a video file is transmitted from computing device 1505 separately from segment information detailing the division into a plurality of portions. Separation during transmission may reduce the ability for interception of an entire video prior to the information being received by a recipient computing device, such as computing device 1510. In still another example, a video is streamed from computing device 1505 (e.g., as a single stream, as multiple streams).

FIG. 16 illustrates another example of a networking environment having a computing device 1605 and a computing device 1610. A video, a divided video, one or more portions of one or more frames of a video, segment information detailing a division of a video, and/or other information may be transmitted from computing device 1605 to computing device 1610. An intermediate computing device 1615 exists between computing device 1605 and computing device 1610. In one example, computing device 1615 is one or more server computing devices. In one such example, computing device 1615 is operated by an entity that provides a service to users of computing device 1605 and computing device 1610 that allows those users to perform any one or more of the embodiments, implementations, features, aspects, etc. for dividing and video, transmitting a video, and/or displaying a video as disclosed herein. Computing device 1605 is connected to computing device 1615 via a network 1620. Computing device 1610 is connected to computing device 1615 via a network 1625. In one example, networks 1620 and 1625 include one or more network segments shared between networks 1620 and 1625. In another example, networks 1620 and 1625 do not share a network segment.

A video, a divided video, one or more portions of one or more frames of a video, segment information detailing a division of a video, and/or other information may be transmitted from computing device 1605 to computing device 1615 and then to computing device 1610.

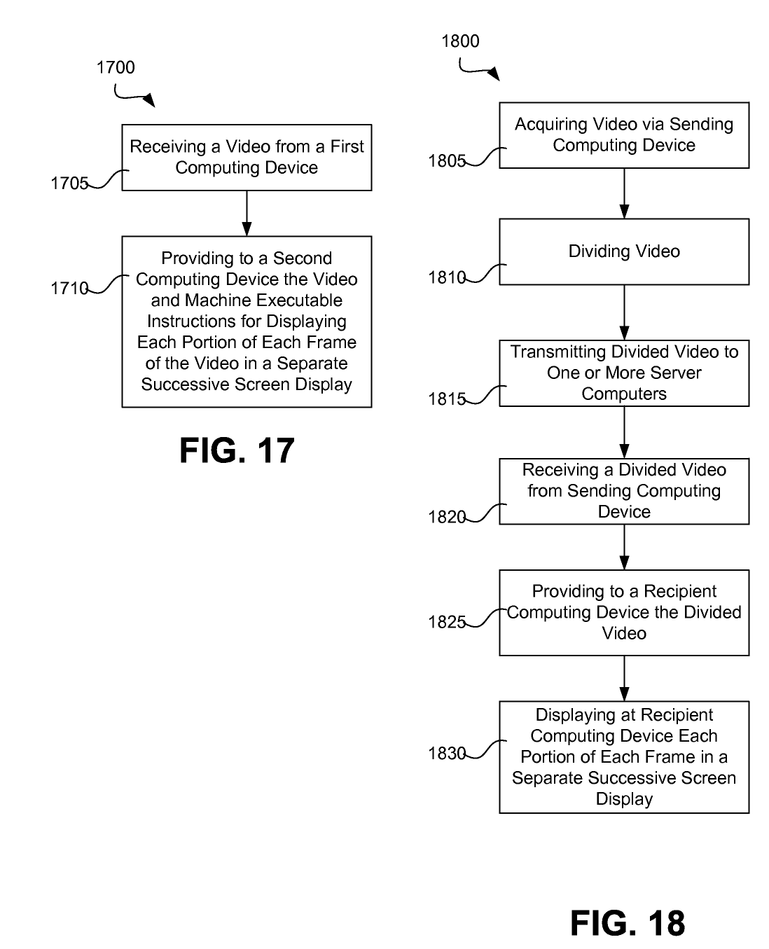

FIG. 17 illustrates one exemplary implementation of a method 1700 of transmitting a video. At step 1705, a video is received by a first computing device. Reception may occur over a network (e.g., as described in examples above with respect to FIGS. 15, 16) or via another form of transmission to the computing device. In one example, the first computing device is one or more server computing devices of a service provider involved in receiving a video (e.g., a divided video and/or an undivided video for dividing prior to display) and providing a recipient user with the video for display according to one or more of the implementations, examples, aspects, etc. of separated display disclosed herein.

At step 1710, the video and machine-executable instructions for displaying each portion of each frame of at least a set of frames of a video in a separate successive screen display are provided by the first computing device (e.g., one or more server computing devices) to a recipient computing device. As discussed herein, there are a variety of ways to divide one or more frames of a video and a variety of ways to display successive screen displays of separated portions of a frame. The machine-executable instructions provided to the recipient computing device may include instructions for displaying each portion separately having any one or more of the features, aspects, etc. of any one or more of the implementations of displaying portions of a frame of a video disclosed herein. Examples of instructions for inclusion in machine-executable instructions for displaying each portion of each frame of at least a set of frames of a video in a separate successive screen display include, but are not limited to, instructions for providing an interface for displaying a divided video via a display element of a computing device, instructions for providing another type of interface, instructions for providing a video display region, instructions for automatically dividing one or more frames of a video into a plurality of portions, instructions for modifying an image parameter of one or more portions of a frame, data representing one or more additional visual information, segment information (e.g., defining one or more locations, subregions, etc. for a plurality of portions of one or more frames of a video), machine-executable instructions for receiving a user instruction via an interface, and any combinations thereof.

In one example, the machine-executable instructions include segment information (e.g., segment information that can be used in conjunction with additional machine-executable instructions provided at a prior time to the second computing device to display the separated portions of the frames). In another example, the machine-executable instructions include segment information provided at about the same time as the video to the second computer and other machine-executable instructions (e.g., in the form of a downloadable “app”) provided to the second computer at a time prior to the video and segment information (e.g., via an “app” download Internet location). In another example, a segment of machine-executable instructions may be part of a video display codec, part of an operating system, part of a package of an operating system, and/or another application of a computing device. In yet another example, one or more functions for displaying an interface or other displayable element according to any of the aspects, methodologies, and/or implementations of the present disclosure may be performed as a hardware function of a graphics processing unit (GPU and/or CPU).

Any part of the machine-executable instructions may be provided to the recipient computing device at the same time or relatively close in time as the time of providing the video to the recipient computing device. In certain implementations, at least a part of the machine-executable instructions are provided at a time prior to the provision of the video to the recipient computing device. In one example, at least a part of the machine-executable instructions for displaying each portion of each frame of at least a set of frames of a video in a separate successive screen display and/or displaying an interface is provided to a recipient computing device as a downloadable application (e.g., an “app”) for execution in conjunction with the video and segment information provided with the video (e.g., as a part of the machine-executable instructions). In one such example, a downloadable application is provided to the recipient computing device by an entity that is also responsible for providing the video to the recipient device (e.g., via one or more server computers of a service provider for sending, dividing, receiving, and/or displaying a video). A downloadable application can be provided to a recipient computing device by an entity via any of a variety of ways. Example ways for an entity to provide a downloadable application to a recipient computing device include, but are not limited to, providing access to one or more server computing devices having the application and being operated by the entity and/or an agent of the entity, the entity and/or an agent of the entity providing access to the application via a third-party application download site (e.g., Apple's App Store, Google's Android App Store, etc.), and any combinations thereof.

In another example, at least a part of the machine-executable instructions for displaying each portion of each frame of at least a set of frames of a video in a separate successive screen display and/or displaying an interface is provided to a recipient computing device via access by the recipient device to a website that actively provides the separated display of the portions via an interaction with the website and one or more Internet browser applications (or a proprietary application designed for interaction with the website) on the recipient computing device.

As discussed herein, a video may be divided at one or more of a variety of points prior to display of a plurality of portions of one or more frames in separate screen displays. Examples of a point prior to display for dividing a video include, but are not limited to, dividing one or more frames into a plurality of portions using a sending computing device (e.g., a computing device that acquires the video), dividing one or more frames into a plurality of portions using an intermediate computing device (e.g., the first computing device of step 1705, one or more server computers, etc.), dividing one or more frames into a plurality of portions using a recipient computing device (e.g., the recipient computing device of step 1710), and any combinations thereof. In one example, the video provided to the recipient computing device is a divided video. In one such example, the machine-executable instructions include segment information. In another example, the video received by the first computing device at step 1705 is a divided video. In yet another example, the video provided to the recipient computing device at step 1710 is undivided and one or more of the frames of the video is divided into a plurality of portions (e.g., via an automated process) at the recipient computing device prior to display via the recipient computing device according to step 1710. In one such example, the machine-executable instructions provided to the recipient computing device (e.g., at a time prior to the provision of the video (for example, as an app)) include instructions for how to divide one or more frames into a plurality of portions (e.g., via an automated process).

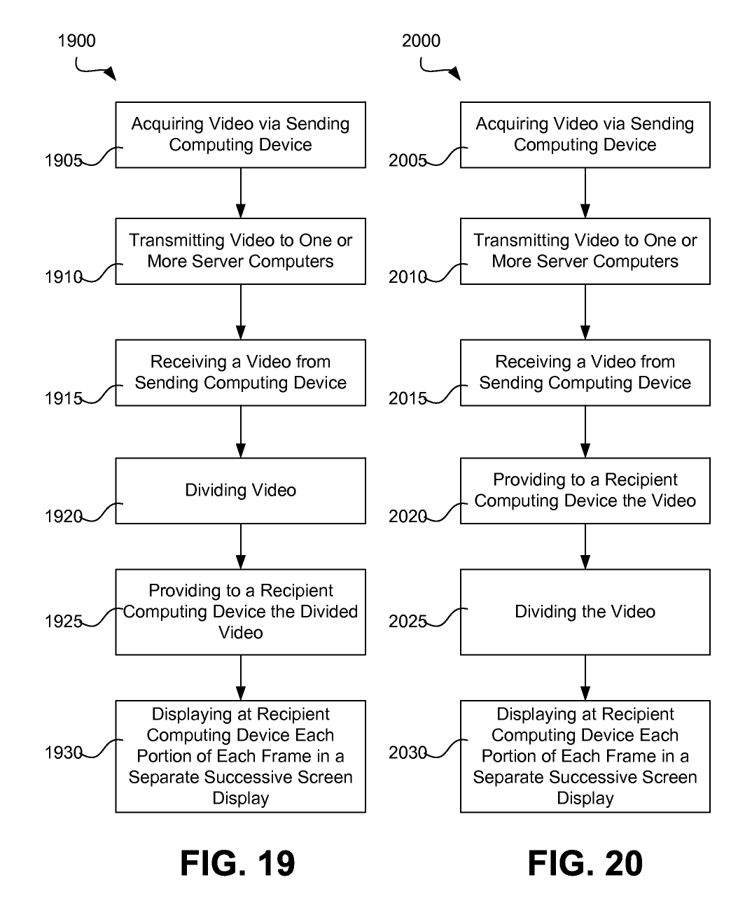

FIGS. 18, 19, and 20 illustrate exemplary implementations of methods of displaying a divided video. Aspects, features, alternatives, examples, and concepts discussed herein with respect to the various implementations for acquiring a video, dividing a video, providing an interface, transmitting a video and/or a divided video, receiving a video and/or a divided video, displaying each of a plurality of portions of each frame in a separate screen display, etc. may also be applicable to the methods described with respect to FIGS. 18, 19, and/or 20. The exemplary implementations of methods discussed with respect to FIGS. 18, 19, and 20 include one or more server computing devices as intermediate computing devices (e.g., as shown in FIG. 16). Similar examples to those discussed with respect to FIGS. 18 and 20 are contemplated with no intermediate computing devices (e.g., as shown in FIG. 15), such as in a peer-to-peer environment.

FIG. 18 illustrates one exemplary implementation of a method 1800 of displaying a divided video. At step 1805, a video is acquired via a sending computing device. At step 1810, each frame of at least a set of the frames of the video is divided into a plurality of portions at the sending computing device. At step 1815, a divided video is transmitted to one or more server computing devices. At step 1820, the divided video is received by the one or more server computing devices. At step 1825, the divided video is provided to a recipient computing device (e.g., with machine-executable instructions for displaying each portion of the divided video in a separate screen display). At step 1830, each portion of each frame of the video (e.g., the frames that were divided at step 1810) is displayed in a separate successive screen display via the recipient computing device.

FIG. 19 illustrates another exemplary implementation of a method 1900 of displaying a divided video. At step 1905, a video is acquired via a sending computing device. At step 1910, the video is transmitted to one or more server computing devices. At step 1915, the video is received by the one or more server computing devices. At step 1920, each frame of at least a set of the frames of the video is divided into a plurality of portions at the one or more server computing devices. At step 1925, the divided video is provided to a recipient computing device (e.g., with machine-executable instructions for displaying each portion of the divided video in a separate screen display). At step 1930, each portion of each frame of the video (e.g., the frames that were divided at step 1910) is displayed in a separate successive screen display via the recipient computing device.

FIG. 20 illustrates yet another exemplary implementation of a method 2000 of a divided video. At step 1905, a video is acquired via a sending computing device. At step 1910, the video is transmitted to one or more server computing devices. At step 1915, the video is received by the one or more server computing devices. At step 1920, the video is provided to a recipient computing device. At step 1925, each frame of at least a set of the frames of the video is divided into a plurality of portions at the recipient computing device. At step 1930, each portion of each frame of the video (e.g., the frames that were divided at step 1910) is displayed in a separate successive screen display via the recipient computing device.

At a sending computing device that transmits a video for separated display via a recipient computing device, an interface may be provided for allowing a user of the sending computing device to designate one or more recipients for the video. Such an interface may be provided before and/or after an interface provided at the sending computing device for dividing a video and may be provided before and/or after an interface provided at the sending computing device for acquiring a video. Any combination of interfaces for designating a recipient; for acquiring a video; for modifying one or more portions of a frame of a video; for dividing a video (e.g., via a representation of one or more frames of a video); for providing one or more additional information to a video, a frame, and/or a portion of a video; and for other functions may be provided in any order that accommodates the desired function of the interface. Additionally, any of the interfaces may be provided as a combined interface (e.g., such that the combined interface displays combined functionality at the same time to a user). Examples of ordering for interfaces include, but are not limited to, providing an interface for acquiring a video prior to providing an interface for designating one or more recipients, providing an interface for acquiring a video after providing an interface for designating one or more recipients, providing an interface for dividing a video prior to providing an interface for designating one or more recipients, providing an interface for dividing a video after providing an interface for designating one or more recipients, providing an interface for allowing a user to modify an image parameter of one or more portions prior to providing an interface for designating one or more recipients, providing an interface for allowing a user to modify an image parameter of one or more portions after providing an interface for designating one or more recipients, providing an interface for inputting one or more additional visual information prior to providing an interface for designating one or more recipients, providing an interface for inputting one or more visual information after providing an interface for designating one or more recipients, and any combinations thereof. Examples of ways to combine functionality in a common screen display interface include, but are not limited to, using different portions of a screen display of an interface for different functionality, superimposing a user actuatable element of a screen display over another element of a screen display (e.g., superimposing user actuatable elements for performing one or more functions over a representation of one or more frames), and any combinations thereof. Examples of a user actuatable element include but are not limited to, a graphical element, a textual element, an image element, an element selectable using a pointer device, an element selectable using a touch screen actuation, and any combinations thereof.

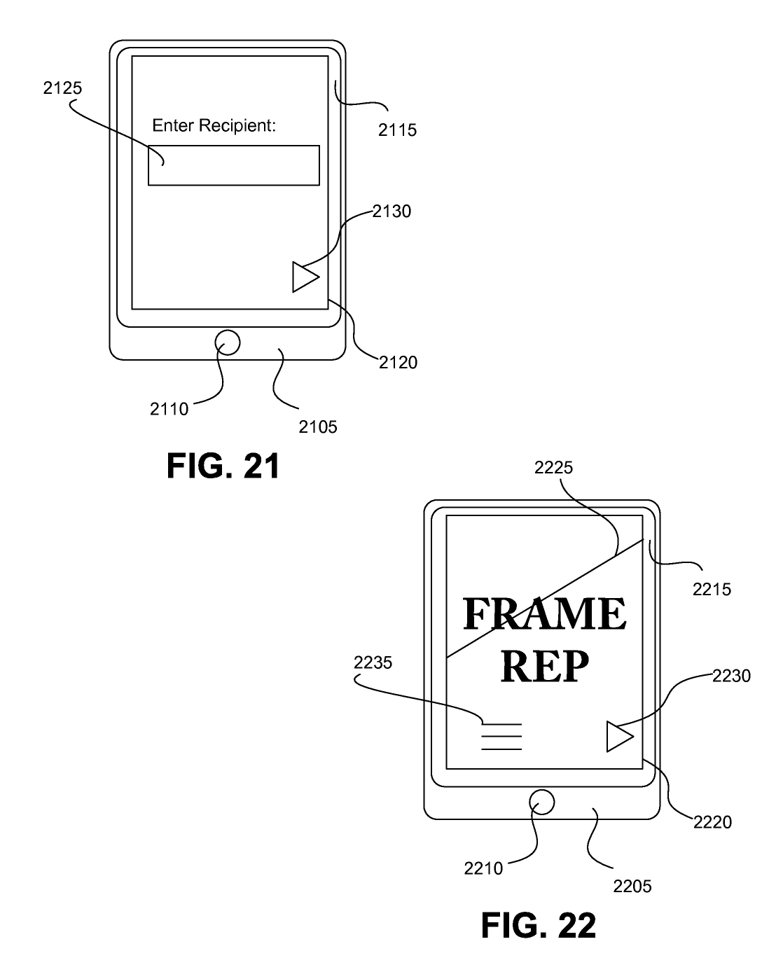

In one exemplary aspect, an interface for allowing a user to designate a recipient may include any interface element that allows the input and/or selection of one or more recipients for a video (e.g., an acquired video, a divided video, etc.). Examples of an interface element that allows the input and/or selection of one or more recipients include, but are not limited to, a text entry element, a list of possible recipients for selection (e.g., recent recipients, recipients in an address book, etc.), a search element (e.g., for searching an address book; for searching other users of a system for dividing, transmitting, and/or displaying a divided video; etc.), a lookup element for looking up a recipient, a graphical element, a textual element, and any combinations thereof. FIGS. 21 and 22 illustrate exemplary interfaces that may be utilized in one or more of the implementations of a sending computing device and/or dividing of a video according to the current disclosure.

FIG. 21 illustrates one exemplary implementation of an interface for designating one or more recipients for a video. A computing device 2105 includes an input element 2110 and a display element 2115 (e.g., a touch screen actuatable display element for interfacing and/or inputting). An interface 2120 is provided via a display region of display element 2115. Interface 2120 includes an interface element 2125 for inputting one or more recipients for a video. In one example, a user may utilize input element 2110 (e.g., via directing a pointer display element designed to move over interface 2120 and/or a pop-up screen displayable keyboard) and/or a touch screen component (e.g., to select a segment of interface 2120 and/or to actuate a pop-up screen displayable keyboard for entering one or more recipients) of display element 2115 to designate one or more recipients. Interface 2120 also includes a user actuatable element 2130 for indicating that designation of one or more recipients is complete. An interface for designating one or more recipients for a video may include a “next” actuatable element, such as actuatable element 2130, configured to allow a user to move to a next interface display screen in a set of interface display screens and/or to begin a transmission of a video (e.g., a divided video, an acquired video). In one example, actuation of element 2130 displays the next interface in an order (e.g., an interface for dividing a video). In another example, actuation of element 2130 begins transmission of a video (e.g., a video acquired via device 2105, a video divided via device 2105 in a prior interface display screen, etc.). In on example, actuation of element 2130 may include utilization of input element 2110 and/or a touch screen component of display element 2115.

FIG. 22 illustrates one exemplary implementation of an interface for dividing a video (e.g., via dividing a representation of one or more frames of the video). A computing device 2205 includes an input element 2210 and a display element 2215 (e.g., a touch screen actuatable display element for interfacing and/or inputting). An interface 2220 is provided via a display region of display element 2215. Interface 2220 is configured to provide a user with an ability to position one of more lines 2225 to divide a representation of one or more frames of the video into a plurality of portions. Interface 2220 also includes a “next” user actuatable element 2230. In one example, actuation of element 2230 displays the next interface display screen in an order. In another example, actuation of element 2230 begins transmission of video. An interface for dividing a video, such as interface 2220, may also include an additional action element 2235 configured to allow a user to perform one or more additional actions. Examples of an additional action include, but are not limited to, providing one or more additional visual information (e.g., text, graphics, etc. for inclusion with one or more portions of one or more frames), selection of a video to be acquired for dividing (e.g., from a folder stored on a memory element of a computing device), actuation of a camera associated with a computing device for acquiring a video, storage of a divided video on a memory element associated with a computing device (e.g., to allow for transmission using a different interface, such as a social networking application), posting a divided video to a social networking service (e.g., Facebook, Instagram, etc.), and any combinations thereof.

Information received via a plurality of interfaces that are provided to a user may be transmitted from a sending computing device in a variety of orders. Such information may be transmitted from a sending computing device at the same time. In one example, an interface for designating one or more recipients is provided, designation of one or more recipients is received via the interface, an interface for dividing a video is provided, an instruction for dividing each frame of at least a set of frames of the frames of a video into a plurality of portions is received, and information regarding the one or more recipients and the divided video is transmitted after the instruction for dividing is received (e.g., at about the same time). In another example, an interface for dividing a video is provided, an instruction for dividing each frame of at least a set of frames of the frames of a video into a plurality of portions is received, an interface for designating one or more recipients is provided, designation of one or more recipients is received via the interface, and information regarding the one or more recipients and the divided video is transmitted after the instruction for dividing is received (e.g., at about the same time). Information provided via a plurality of interfaces may also be transmitted from a sending computing device at different time. In one example, an interface for designating one or more recipients is provided, designation of one or more recipients is received via the interface, transmission of information regarding the one or more recipients is started at a time prior to the receipt of instructions for dividing a video, an interface for dividing a video is provided, an instruction for dividing each frame of at least a set of frames of the frames of a video into a plurality of portions is received, and the divided video is transmitted after the instruction for dividing is received. In another example, an interface for dividing a video is provided, an instruction for dividing each frame of at least a set of frames of the frames of a video into a plurality of portions is received, transmission of the divided video is started prior to designation of one or more recipients, an interface for designating one or more recipients is provided, designation of one or more recipients is received via the interface, and information regarding the one or more recipients is transmitted after the instruction after receipt of the designation. Other variations of transmission are also possible. Streaming in one or more streams to one or more recipient computing devices is also contemplated as a mode of transmission.

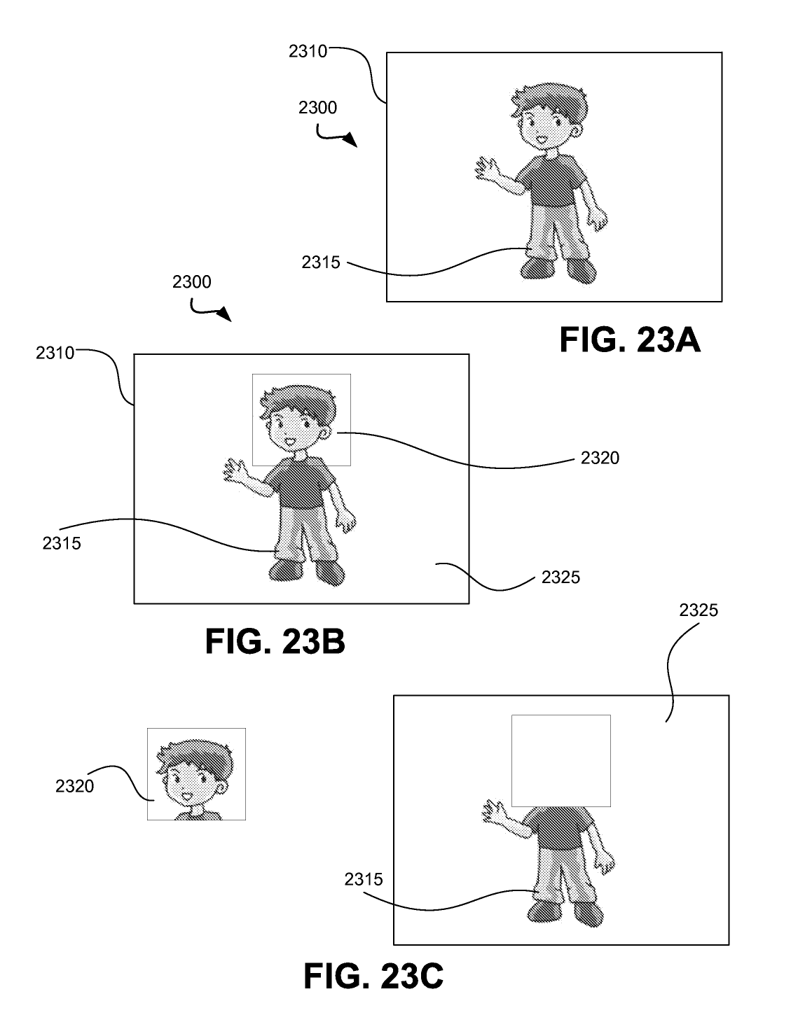

FIGS. 23A to 23C illustrate one exemplary implementation of a way of automatically dividing a frame of a video. A representation of one or more frames 2310 includes an area bound by a perimeter 2310. Representation 2310 includes a subject 2315 having a face. Automatic facial recognition can be utilized to identify a subregion of the area having at least a part of the face of subject 2315. FIG. 23B illustrates an example dividing of representation 2310 into a portion 2320 and a portion 2325 using automatic facial recognition. Various forms of automatic facial recognition are known and can be utilized with the current methods and implementations. FIG. 23C illustrates separated display of portion 2320 and portion 2325.

It is to be noted that any one or more of the aspects and embodiments described herein may be conveniently implemented using one or more machines (e.g., one or more computing devices, such as computing device 700 of FIG. 7) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above that lend themselves to employing software and/or software modules may also include appropriate hardware for assisting in the implementation of the machine executable instructions of the software and/or software module.

Such software may be a computer program product that employs a machine-readable hardware storage medium. A machine-readable hardware storage medium may be any medium that is capable of storing and/or encoding a sequence of instructions for execution by a machine (e.g., a computing device) and that causes the machine to perform any one of the methodologies and/or embodiments described herein. Examples of a machine-readable hardware storage medium include, but are not limited to, a solid state memory, a flash memory, a random access memory (e.g., a static RAM “SRAM”, a dynamic RAM “DRAM”, etc.), a magnetic memory (e.g., a hard disk, a tape, a floppy disk, etc.), an optical memory (e.g., a compact disc (CD), a digital video disc (DVD), a Blu-ray disc (BD); a readable, writeable, and/or re-writable disc, etc.), a read only memory (ROM), a programmable read-only memory (PROM), a field programmable read-only memory (FPROM), a one-time programmable non-volatile memory (OTP NVM), an erasable programmable read-only memory (EPROM), an electrically erasable programmable read-only memory (EEPROM), and any combinations thereof. A machine-readable hardware storage medium, as used herein, is intended to include a single medium as well as a collection of physically separate media, such as, for example, a collection of compact discs or one or more hard disc drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Some of the details, concepts, aspects, features, characteristics, examples, and/or alternatives of a component/element discussed above with respect to one implementation, embodiment, and/or methodology may be applicable to a like component in another implementation, embodiment, and/or methodology, even though for the sake of brevity it may not have been repeated above. It is noted that any suitable combinations of components and elements of different implementations, embodiments, and/or methodologies (as well as other variations and modifications) are possible in light of the teachings herein, will be apparent to those of ordinary skill, and should be considered as part of the spirit and scope of the present disclosure. Additionally, functionality described with respect to a single component/element is contemplated to be performed by a plurality of like components/elements (e.g., in a more dispersed fashion locally and/or remotely). Functionality described with respect to multiple components/elements may be performed by fewer like or different components/elements (e.g., in a more integrated fashion).

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed:

1. A method of transmitting an electronic video, the method comprising:
receiving a video over a network from a first computing device, the video including a plurality of frames; and
providing the video and machine executable display instructions to a second computing device, the machine executable display instructions allowing the second computing device to display a set of separate successive screen displays for each frame of at least a set of the plurality of frames in a video display region, the video display region having an area representative of a frame of the video, each frame of the at least a set of the plurality of frames being divided into a plurality of portions, the displaying a set of separate successive screen displays including displaying each portion of the plurality of portions for the frame in a separate successive screen display in a subregion of the area that corresponds to the location of the portion in the corresponding frame and displaying one or more substitute portions in any subregion not having the portion.

2. A method according to claim 1, wherein the video and the machine executable display instructions are transmitted over a network to the second computing device.

3. A method according to claim 1, wherein at least a part of the machine executable display instructions are provided to the second computing device prior to transmitting the video to the second computing device over a network.

4. A method according to claim 3, wherein the at least a part of the machine executable display instructions are provided to the second computing device via an intermediary server computing device.

5. A method according to claim 1, further comprising dividing each of at least a set of the plurality of frames into a plurality of portions prior to providing the video to the second computing device.

6. A method according to claim 5, wherein the dividing occurs after the receiving a video over a network.

7. A method according to claim 5, wherein the providing a video to a second computing device includes providing a divided video including one or more video files and segment information defining a location of each portion of the plurality of portions.

8. A method according to claim 1, wherein the receiving a video over a network includes receiving a divided video wherein each of the plurality of frames is divided into the plurality of portions.

9. A method according to claim 1, wherein the video is divided at the second computing device after the video is provided to the second computing device.

10. A method according to claim 1, wherein each frame of at least a set of the plurality of frames is divided into a plurality of polygon shaped portions.

11. A method according to claim 1, wherein a shape and size of each corresponding respective portion of a first frame of the plurality of frames is the same shape and size of each corresponding respective portion of a second frame of the plurality of frames.

12. A method according to claim 1, wherein a shape and/or size of at least one corresponding respective portion of a first frame of the plurality of frames is different in shape and/or size from the corresponding respective portion of a second frame of the plurality of frames.

13. A method according to claim 1, wherein the one or more substitute portions includes a substitute portion selected from the group consisting of a greyscale portion, a black portion, a white portion, a colored portion, a blurred version of the original portion, a version of the original portion having a filter applied, a version of the original portion having one or more image parameters modified, a user-defined substitute displayable element, and any combinations thereof.

14. A method according to claim 1, further comprising providing at least one of the one or more substitute portions to the second computing device.

15. A method according to claim 1, wherein the plurality of frames are arranged in the video in a first order and the machine executable display instructions include instructions to allow the display of a set of separate successive screen displays such that the order of the display of the sets of separate successive screen displays replicates the first order.

16. A method according to claim 1, wherein the plurality of frames are arranged in the video in a first order and the machine executable display instructions include instructions to allow the display of a set of separate successive screen displays such that the order of the display of the sets of separate successive screen displays is different from the first order.

17. A method according to claim 1, wherein the machine executable display instructions includes information allowing the displaying of each portion of the plurality of portions for the frame in a separate successive screen display such that the screen display rate equal to the frame rate of a display element used for displaying the screen displays divided by the number of portions in the plurality of portions.

18. A method according to claim 1, wherein the machine executable display instructions includes information allowing the displaying of each portion of the plurality of portions for the frame in a separate successive screen display such that the successive screen displays are displayed via the first computing device at a screen display rate perceivable by a human user to have the plurality of portions for a particular frame appear to be an undivided display of the particular frame.

19. A system for transmitting an electronic video, the system comprising:
a means for receiving a video over a network from a first computing device, the video including a plurality of frames; and
a means for providing the video and machine executable display instructions to a second computing device, the machine executable display instructions allowing the second computing device to display a set of separate successive screen displays for each frame of at least a set of the plurality of frames in a video display region, the video display region having an area representative of a frame of the video, each frame of the at least a set of the plurality of frames being divided into a plurality of portions, the displaying a set of separate successive screen displays including displaying each portion of the plurality of portions for the frame in a separate successive screen display in a subregion of the area that corresponds to the location of the portion in the corresponding frame and displaying one or more substitute portions in any subregion not having the portion.

20. A machine-readable hardware storage medium containing machine executable instructions for transmitting an electronic video, the instructions comprising:
a set of instructions for receiving a video over a network from a first computing device, the video including a plurality of frames; and
a set of instructions for providing the video and machine executable display instructions to a second computing device, the machine executable display instructions allowing the second computing device to display a set of separate successive screen displays for each frame of at least a set of the plurality of frames in a video display region, the video display region having an area representative of a frame of the video, each frame of the at least a set of the plurality of frames being divided into a plurality of portions, the displaying a set of separate successive screen displays including displaying each portion of the plurality of portions for the frame in a separate successive screen display in a subregion of the area that corresponds to the location of the portion in the corresponding frame and displaying one or more substitute portions in any subregion not having the portion.
